(19) United States
(12) Patent Application Publication
(10) Pub. No.: US 2026/0119918 A1
(43) Pub. Date: Apr. 30, 2026

(54) ORCHESTRATION OF DISTRIBUTED INFERENCE OPERATIONS

(71) Applicant: Nvidia Corporation, Santa Clara, CA (US)

(72) Inventors: Alireza Farshin, Stockholm (SE); Omri Kahalon, Alberta (CA); Vishwanath Venkatesan, Austin, TX (US); Timothy Paul Stamler, Austin, TX (US)

(21) Appl. No.: 18/926,233

(22) Filed: Oct. 24, 2024

(51) Int. Cl. G06N 5/04; G06F 9/48

(52) U.S. Cl. CPC G06N 5/04; G06F 9/4843

(57) ABSTRACT

Approaches presented herein provide for the management of resources to be used to process a request, such as may involve orchestration of nodes for an inference request. Upon receiving an inference request, an orchestrator can determine a sequence of context nodes and inference nodes to be used to process the inference request, based in part upon a determined class of inferencing to be performed. The orchestrator can append metadata to the inference request that identifies the sequence, and can transmit the appended request to one or more first nodes in the sequence. If the nodes have a network programmable device, or similar capability, the request can be forwarded to the nodes in sequence without having to go back to the orchestrator between nodes.

### TECHNICAL FIELD

This disclosure relates to the management of a set of computing resources, and in at least one embodiment relates to the accelerated deployment and orchestration of distributed inference devices through the use of one or more programmable network devices.

### BACKGROUND

In various computing environments—particularly those that use large language models (LLMs) or other models with a large number of parameters—it can be beneficial to distribute a set of computing operations across a large set of computing resources, such as physical or virtual servers. Tasks such as training and performing inferencing can take a significant amount of time and resources to perform, even when distributing over a large set of resources. In many instances, however, it is difficult to account for this higher demand while also maintaining various performance or quality of service metrics. Certain frameworks have been proposed to the process of building and optimizing LLM applications, where the frameworks run on central processing unit (CPU)-based servers and offer development kits or interfaces to enable users to use different entities required for LLM-based applications, such as various inference systems, models, and vector databases (VDBs). These frameworks primarily focus on building monolithic LLM pipelines for a single application and expect users to set up and configure various entities separately, while more complicated LLM-based applications require more dynamic pipelines. This may occur when, for example, a request for inferencing requires different or multiple models, as well as specific contextual information. Various artificial intelligence (AI) service providers have started offering different classes of services and models of operation, which necessitates a more complex orchestration of inference requests. For instance, an inference request may be directed to a certain model according to the user class and/or the user requirement (e.g., the level of accuracy and/or the task category). Moreover, a request may need to be served via multiple specialized models sequentially or in parallel, using a mixture of agents or agentic workflows, which makes orchestration even more complex and important. Current approaches do not provide a mechanism to efficiently and dynamically perform inference requests accordingly to the configurations of various service providers without using unnecessary hardware resources, such as a plurality of CPU cores. Further, prior models tend to be simple and monolithic, without the ability to support variable length chains.

### BRIEF DESCRIPTION OF THE DRAWINGS

Various embodiments in accordance with the present disclosure will be described with reference to the drawings, in which:

FIG. 1 illustrates an example network architecture that can be used to perform computing operations, according to at least one embodiment;

FIG. 2 illustrates a flow of actions to be performed during an initialization phase, according to at least one embodiment;

FIG. 3A illustrates a flow of actions to be performed during an operational phase, according to at least one embodiment;

FIG. 3B illustrates a flow of actions to be performed with metadata appended to a request during an operational phase, according to at least one embodiment;

FIG. 4A illustrates an example process that can be performed during an initialization phase for a set of resources, according to at least one embodiment;

FIG. 4B illustrates an example process that can be performed during an operational phase for a set of resources, according to at least one embodiment;

FIG. 4C illustrates an example process that can be performed to process an inference request using a set of resources, according to at least one embodiment;

FIG. 4D illustrates an example process that can be performed during an initialization phase for a set of resources, according to at least one embodiment;

FIG. 5 illustrates an example data center system, according to at least one embodiment;

FIG. 6 is a block diagram illustrating a computer system, according to at least one embodiment;

FIG. 7 is a block diagram illustrating a computer system, according to at least one embodiment;

FIG. 8 illustrates a computer system, according to at least one embodiment;

FIG. 9 illustrates a computer system, according to at least one embodiment;

FIG. 10 illustrates exemplary integrated circuits and associated graphics processors, according to at least one embodiment;

FIGS. 11A, 11B illustrate exemplary integrated circuits and associated graphics processors, according to at least one embodiment;

FIG. 12 illustrates a computer system, according to at least one embodiment;

FIG. 13A illustrates a parallel processor, according to at least one embodiment;

FIG. 13B illustrates a partition unit, according to at least one embodiment; and

FIG. 14 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various illustrative embodiments can provide for the management of computing resources used for various computing tasks. This can include providing for the accelerated deployment and/or orchestration of distributed inference devices through the use of one or more programmable network devices, such as one or more data processing units (DPUs) or network interface cards (e.g., SmartNICs). In order to avoid the overhead of prior solutions where central processing units (CPUs) are to be directly involved in all operations and support for complex pipelines is limited, programmable network devices can be used to perform tasks such as orchestration to cause a request to be directed one or more nodes able to perform one or more tasks for an inference operation. This can include sending individual requests to one or more context nodes, to obtain information useful for inferencing, and to one or more inference nodes (or computing/processing device capable of performing at least one inferencing operation) to actually perform the inferencing. A dynamic pipeline can be selected for a specific inferencing operation, and the ordering and selection of nodes to be used for the operation (according to the selected pipeline) can be appended to the request as metadata. Such a pipeline can thus be at least partially request-aware or request-dependent, and can adapt as appropriate. The format of the metadata allows these various nodes to communicate without the need to send the requests and/or responses back to the orchestrator after each step. Various types of context can be fetched, in parallel or sequence, from one or more context nodes, and the type of inference node(s) to be used may be based in part upon factors such as user preference and a class associated with a received request. Different inference nodes may contain different AI models, and in some instances multiple inferences can be generated and compared to select a final output. Such an approach can provide a future-ready and network-accelerated solution to address the aforementioned and other such challenges and requirements, such as for future LLM-based applications.

Variations of this and other such functionality can be used as well within the scope of the various embodiments as would be apparent to one of ordinary skill in the art in light of the teachings and suggestions contained herein.

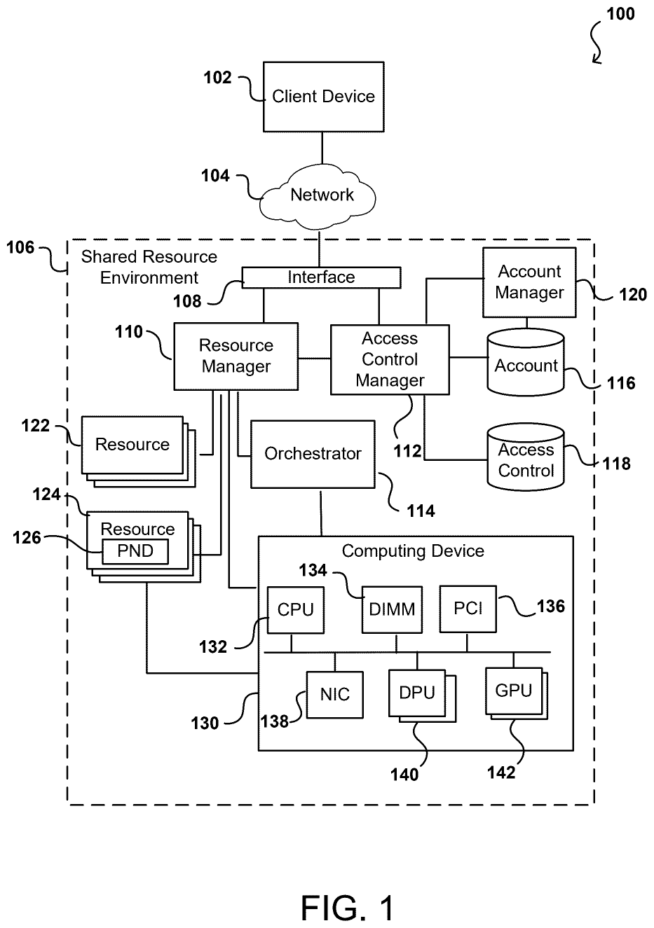

FIG. 1 illustrates an example system 100 that can be used to perform computing operations, as may relate to distributed inference requests, according to at least one embodiment. As mentioned, there are various computing environments in which processing of data can be performed. Examples of such environments include data centers and multi-tenant resource provider environments, such as may provide a set of cloud computing services. These environments can be used to perform various computing operations on behalf of a number of different users, parties, or entities, such as by using a pool of available resource capacity. FIG. 1 illustrates an example architecture 100 for such an environment that can be used in accordance with at least one embodiment. In this example, a user is able to use a client device 102 to submit one or more requests to access one or more resources, or to perform a task using one or more resources, among other such options. Such a request can be submitted over at least one network 104, such as the Internet or a cellular network, and received to an interface, address, or endpoint in a shared resource environment 106. The request can be received to an interface, such as an application programming interface (API) of an interface layer 108. In this example, a request from a client device 102 may first need to be analyzed to determine whether the client device, user, or other entity associated with the request has access to one or more resources to be used to process the request, as well as to determine whether the type of access permitted allows for performance of the requested operation.

In this example, information for the request can be directed to an access control manager 112, or other such component, system, or service. The access control manager 112 can perform various tasks to determine and/or manage access to a set of shared resources, such as to extract relevant information from a received request and compare information for the request against information in an account repository 116 or other such location. This operation, as may be performed by or in combination with an account manager 120, can be used to determine whether the request is associated with a valid account associated with the shared resource environment, such as an account maintained by a user with a provider of the shared resource environment 106. Once determined, that account information can be used to determine the type of access permissible to perform one or more operations associated with the request. This may include, for example, determining (or verifying) an authorized user identifier associated with the request, then using that user identifier to determine access permissions associated with that user identifier, as may be stored in an access control data repository 118 or other such location. In at least one embodiment, an access control manager 112 may include various modules to perform specific tasks, such as an authorization module and an authentication module, or may run on a network server that also has these modules available for use with the access control manager 112, among other such options.

Once a set of access permissions is identified that is associated with the request, the access control manager 112 (or an associated process) can determine whether the necessary permissions exist in the set to process the request which was received from the client device and associated with the user identifier. If the appropriate permissions are determined to exist or be available, the access control manager 112 can direct information for the request to one or more shared resources (and/or potentially dedicated resources) in the shared resource environment 106. In some embodiments, the access control manager 112 may work with a resource manager 110 to determine a specific instance of a type of resource to be used to perform an operation with respect to the request, where the resource manager 110 can perform other types of operations as needed, such as to allocate additional capacity of a type of resource, launch a new compute instance, or perform another such task associated with the request.

In allocating resources, a resource manager 110 may allocate based at least in part on the capability (as well as availably and other such factors) of different types of resources. This may include, for example resources 122 such as physical or virtual servers, or compute instances, that can perform various tasks. There may also be types of resources 124 that contain specific devices or components, or otherwise have additional or specific capabilities, that enable those resources 124 to perform different types of tasks. For example, in this example there may be resources 124 that each include one or more programmable network devices (PNDs) 126 that can perform additional tasks, such as to parse, reformat, and transmit requests to perform one or more computing operations. A resource manager 110 may then allocate one or more of these types of resources 122, 124 based in part upon the types of operations that may be needed for a given user. An example computing device 130 is illustrated that corresponds to a type of resource with a PND. In this example, in addition to conventional components such as a CPU 132, one or more graphics processing units (GPUs) 142, at least one DIMM 134 or other memory device, and a PCI device 136, for example, this computing device 130 includes a pair of programmable network devices (PNDs), in the form of a NIC 138 and at least one DPU 140. As mentioned, these PNDs can be used to perform specific tasks that may not be possible using resources 122 of a type that do not include such devices or functionality.

In at least one embodiment, the resource manager 110 can work with an orchestrator 114 that is able to direct requests to the resources needed to perform a given request. For example, an inferencing request may need to be forwarded (or a separate request transmitted) to a resource that is functioning as a context node, in order to provide contextual information (or other such data) determined to be relevant to the request, or an operation to be performed for the request. An inferencing request may also need to be forwarded to at least one resource functioning as an inferencing node, in order to perform at least one inferencing operation for the request, as may include using contextual information received from at least one context node.

In order to simplify tasks such as the orchestration of distributed inference requests, approaches in accordance with various embodiments can leverage one or more network-accelerated solutions. This can include, for example, using a centralized and distributed orchestrator 114 to efficiently configure the relevant components across the relevant computing environment. A network-accelerated approach can help to minimize communication overhead, allowing for direct communication between different entities participating in an inference operation. Such an approach can also allow hardware resources to be used more efficiently and reduce power consumption, such as where programmable network devices can be used to perform the orchestration, which can free up CPU-based servers to perform more “important” tasks. Such approaches can also support advanced LLM applications that may use different classes of service and multiple models.

A component or service such as an orchestrator 114, which can be referred to as an “inference orchestrator” when used with inferencing requests or tasks, can help to efficiently deploy and orchestrate distributed inference-related operations and resources. An orchestrator 114 can handle any and/or all operations related to an initialization phase, which may involve tasks such as configuring different entities based on the workload and user configuration, and an operational phase, which may involve tasks such as receiving a request and scheduling/dispatching the request to the appropriate entities. As an example, an orchestrator 114 during an operational phase may receive an inference request from a client device 102, such as a desktop computer or operator terminal, and can attempt to classify the request. The orchestrator 114 can then fetch the appropriate context for the request from the appropriate context nodes in the network, and can cause the inference request to be executed on the relevant inference nodes. The context data can be in any appropriate form, such as text, audio, video, image, code, latent vector, and the like. After such execution is completed, the orchestrator 114 can return the inference response to the client device 102 and/or forward to a target destination or address. An orchestrator 114 may also append the request with additional metadata to enable different entities to communicate directly, eliminating unnecessary communication overhead.

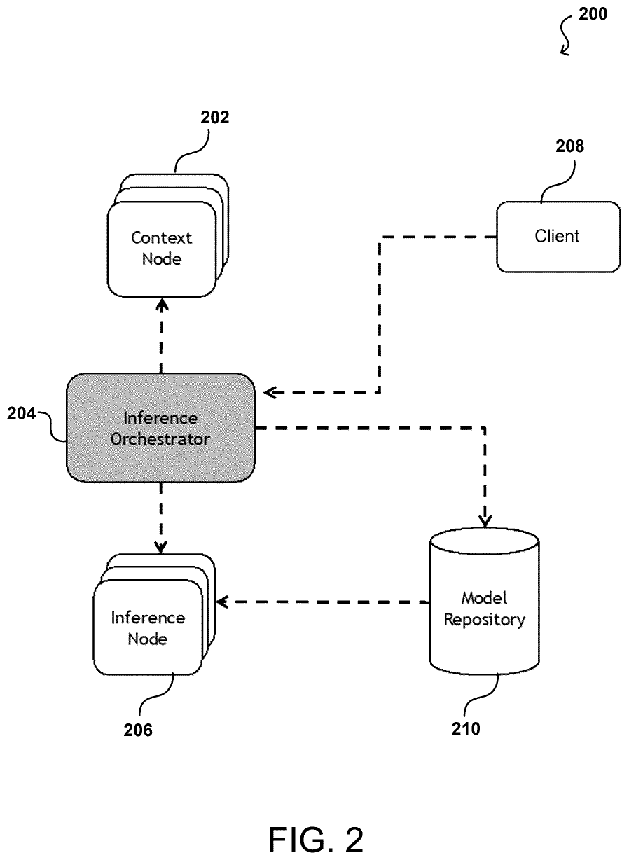

FIG. 2 illustrates an overview 200 of a flow of tasks to be performed by an inference orchestrator 204 during an example initialization phase, according to at least one embodiment. In this example, a user or administrator can use a client device 208 to provide information about the configuration required for deployment and orchestration of inference operations. An inference orchestrator 204 can process this information for use in applying the appropriate configuration. In this example, the received configuration information can include a description of the various nodes, or types of nodes, to be used. The description may include, for example, details of the physical and/or virtual machines to be used to deploy various nodes, as may include inference nodes 206, context nodes 202, and a model repository 210, among other such options. For example, there may be processing nodes (such as individual processing units, cores, or other such physical or virtual elements with processing capability) indicated in an inference pipeline that perform tasks that are potentially unrelated to inferencing, such as upscaling or super-resolution for an AI-generated image. A user may provide relevant information for deploying the nodes as a cluster of nodes to work together to run one or more containerized applications, such as may be in the form of a Kubernetes cluster. This information may also specify whether certain nodes are to be equipped with network accelerators (e.g., DPUs and smart NICs), and whether network acceleration is to be supported.

An inference orchestrator 204 can also specify the format of requests for these inference operations, such as may involve HTTP/REST or L4+ protocol headers, in order to ensure that the inference orchestrator 204 can properly to parse the request messages and/or packets. One or more users can provide the metrics to be used to orchestrate the inference requests. In one example, a user or administrator may specify different models for different types of requests. A request type may be defined according to the request size (e.g., prompt length), request class (e.g., free or premium user), request requirement (e.g., the minimum required accuracy that could affect the selected model size), and/or request task category (e.g., coding prompt, translation prompt, and/or image generation prompt), among other such options. Additionally, a user may specify how many hardware resources (e.g., how many GPUs) or how much resource capacity should be used for each type of request. An inference orchestrator 204 can specify one or more inference modes, as may specify whether various inference operations should be performed in a centralized manner or a distributed manner. An inference orchestrator 204 can also specify one or more supported models, as well as the classes of requests for which each supported model should be used. An inference orchestrator 204 can also specify one or more policies, as may relate to scheduling, quality of service, or other such aspects. Such policy information can be used to schedule and/or prioritize various inference requests, as may be determined according to the request types discussed previously. Additionally, scheduling and prioritization may also impact the way the certain requests traverse in the network based on various load balancing, routing, and other such decisions.

An inference orchestrator 204 can deploy various entities using this and other relevant configuration information. This may involve interacting with at least with one entity, such as an inference node 206, as well as other objects or components such as one or more multiple context nodes, model repositories, and/or additional inference nodes. In this example, a model repository 210 can be accessed by an inference orchestrator 204 to load the appropriate model and model weights on relevant inference nodes. This may include, for example, loading model weights on a graphics processing unit (GPU) or an AI accelerator. An inference orchestrator 204 can also prepare and configure nodes equipped with programmable network devices (e.g., data processing units (DPUs)) in order to enable these devices to parse the metadata attached to the request and redirect or forward the responses (and new requests) to the appropriate nodes. After such configuration and deployment is performed, the underlying inference infrastructure can be ready to service specific types of AI requests.

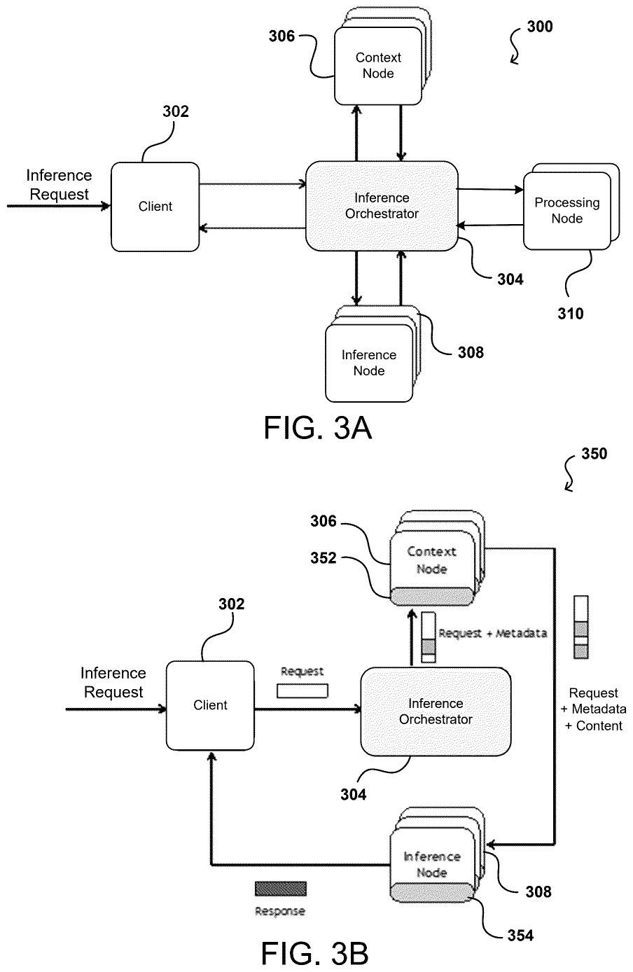

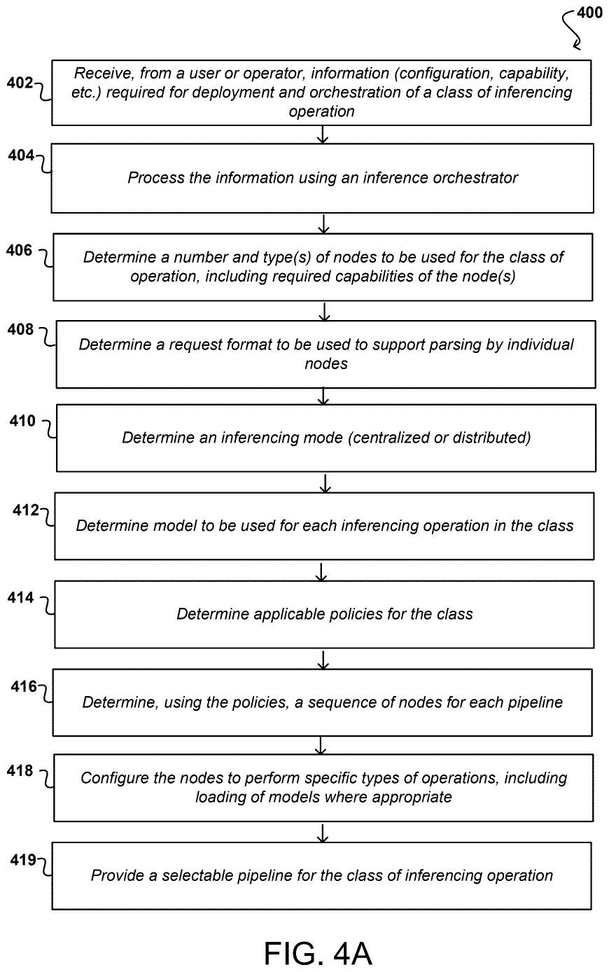

After successful configuration and deployment, an inferencing system 300, such as that illustrated in FIG. 3A, can move into an operational phase in at least one embodiment. In such a phase, an inference orchestrator 304 can perform various tasks in order to serve, for example, a received inference request (or other request requiring inferencing or other such types or processing). An inference request can be transmitted from a client 302, and can be directed to an inference orchestrator 304. The inference orchestrator 304 can parse the received request according to a previously-defined format, as discussed previously. The inference orchestrator 304 can attempt to classify the request based in part on this (and potentially other relevant) information, and can then select one or more appropriate context nodes and one or more inference nodes. Classification may include, for example, analyzing a prompt included in the request to attempt to determine a type of inferencing operation to be performed for the prompt. One or more context nodes 306 may be selected or identified that can provide contextual information useful for one or more corresponding inferencing operations, may relate to, for example, a chat history or additional information from a vector database (VDB). One or more inference nodes 308 can also be selected in order to perform one or more inferencing operations on behalf of the request, as may correspond to compute nodes that use or host AI models that are determined to satisfy one or more requirements for the request requirements. An inference orchestrator 304 can have access to multiple inference nodes 308 that may have different levels of accuracy, size, and/or expertise, among other such differentiating aspects. For instance, if there are multiple models available with different expertise, such as where each model is specialized for a certain task, an inference orchestrator 304 may use techniques based on vector embedding, for example, to choose the appropriate model or perform inference on all of them. As discussed, there may be other types of nodes used as well, such as one or more processing nodes 310 used to perform processing that may be unrelated to inferencing, and that may provide other types of information to be transmitted to the inference orchestrator 304.

After selecting one or more appropriate nodes, an inference orchestrator 304 can append the original request with additional metadata to facilitate direct communication between various nodes or other such entities, at least when an inference node is set to a “distributed” or similar mode of operation. In case of a centralized inference mode as illustrated in FIG. 3A, an inference orchestrator 304 might stay in the loop without adding any metadata to the request. As illustrated in the operational mode 350 of FIG. 3B, such a system may be configured to operate in a distributed mode, where the request does not need to be forwarded back to an inference orchestrator 304 after each individual node in an inference pipeline, at least as long as the respective nodes have the capability to parse, reformat, and/or transmit modified requests. In a distributed operation mode, the inference orchestrator can add or append metadata to a received request. Added metadata can include information such as the address and request for one or more subsequent nodes in an inferencing pipeline for a class of inference to be performed. Added metadata may also include information about an intended recipient of a final result and other such information. If one or more operations are to be performed in parallel, such as to perform an inferencing operation using two different models that will produce two different results, the metadata may also specify criteria for picking one of the results, or for combining the results together into a single response, among other such options. For example, the metadata might specify a formula to use to generate a result score, and then indicate whether to select the result with the highest result score, etc. Having this information embedded in the metadata avoids the need to go back to the inference orchestrator for calculation, result selection, or other such operations, unless such operations are unable to be performed on the relevant node(s).

When adding or appending metadata, various nodes can exploit programmable network devices 352, 354 (e.g., DPUs) executing on, or in conjunction with, a computing device associated with a given node, such as a context node 306 or an inference node 308, in order to facilitate integration of metadata handling and/or parsing in the nodes without modifying the existing software. In one example, a DPU in a node can receive a request with added metadata, and can provide the request with the appropriate format to the software. The DPU can then use the metadata to reformat the request, as appropriate, and send the request to the next node. The inference orchestrator 304 together with the programmable network devices 354 provides for acceleration of the inference operation. If one or more nodes are not equipped with a programmable network device (e.g., a DPU), an inference orchestrator 304 can add itself as one of the nodes in the metadata, and may then participate only in a subset of the inter-node communications where specific nodes may not have the appropriate capabilities needed to process and forward requests without sending the request back to an inference orchestrator 304.

An inference orchestrator 304 can send a received inference request, including the appended metadata, to the relevant node(s), including context nodes 306 and/or inference nodes 308. In a centralized mode, this process can be performed sequentially until the inference orchestrator 304 receives responses from all the relevant nodes, at which point the inference orchestrator 304 can produce a final response for the request. The inference orchestrator 304 can then send the response to the client 302 and/or another designated recipient. In a distributed inference mode, for example, a final response can also be sent directly from the last inference node, effectively bypassing the inference orchestrator 304. If the inference is performed on multiple models, an inference orchestrator 304 may stay involved in the response process. The inference orchestrator 304 can use various approaches to generate the final or combined response. For example, in cases where responses from different models are complementary, one node can combine all of the responses. This node can be a programmable network device (e.g., DPU), such as the one running the inference orchestrator 304 or one from an inference node 308. Since multi-model inference can be performed in parallel, information can be added via the metadata to enable all inference nodes aggregating their response in one place, such as one specific inference node. In various situations it may be desired to only select one of the responses. For example, a vector embedding of all inference responses can be calculated, and then a result nearest to the vector embedding of the request identified and returned. In such a situation, an inference orchestrator 304 can perform and/or coordinate additional steps or tasks, as needed, before returning a response to a client 302 or other designated recipient.

Such an approach provides various advantages over existing solutions. For example, an inference orchestrator can fetch contexts concurrently from multiple context nodes. This can include, for example, information such as chat history and additional data from a vector database. An inference orchestrator can select the appropriate inference node(s) based in part on factors such as user preference and request type and/or class. For example, a prompt received in a request may ask to return an answer, with a description and an image, where determining the answer, generating a plain language description, and generating an appropriate image may each require a different machine learning model that is likely executing on a different computing node. An inference orchestrator an also cause inference to be performed (such as by using a set of inference microservices, such as may be provided using NIMs from NVIDIA Corporation, or AI-optimized servers) on multiple AI models, including specialized models such as mixture of agents models, multi-modal models, and models with different sizes and/or accuracies, among other such options. An inference orchestrator can add metadata to a received request that can be used to mitigate communication overhead in the inference operations, such as where network accelerated nodes can parse the metadata and redirect requests to the next nodes. In at least one embodiment, an inference orchestrator can also combine, merge, and/or select one or more specifics response of multiple inference nodes in cases where the orchestrator sends a request to multiple inference nodes.

Such approaches can provide a framework where requests can be treated differently based on various factors that may be associated with the requests. For example, there may be different quality of service (QoS) requirements for different requests, which may require directing those requests (or information for those requests) to a different set of nodes, or multiple set of nodes. Such approaches can also help to minimize communication overhead by allowing for different paths and types of communication, where nodes can communicate directly with each other rather than having to go through a central orchestrator for every communication. While a central inference orchestrator may be used, the orchestrator does not need to be an intermediary for all communications. An inference orchestrator can, upon receiving an inferencing request, analyze the request and make various decisions about the information needed and/or tasks to be performed for the request. The orchestrator can then append appropriate metadata to the request based in part on these decisions, where that metadata can include information such as the nodes that are to be participating in the corresponding operations. The orchestrator can then send the request, with the appended metadata, to the first node (or a first set of nodes) selected to be used to process the request. The nodes can be equipped with a programmable network device, or other such mechanism or capability, that can parse the metadata and extract the information that is needed for an operation to be performed by that particular node. After performing the respective operation(s), a node can form or generate a new response that builds on the previous request and metadata to include the result(s) of the operation(s), and can forward that request to the next node (or set of nodes) in a determined sequence instead of returning the request back to the orchestrator, unless this is a final response that is intended to be returned to the orchestrator, etc. In the event that a given node does not have a programmable network device or similar capability, the request for that node can be directed back to the orchestrator to update and send to the next node, as appropriate.

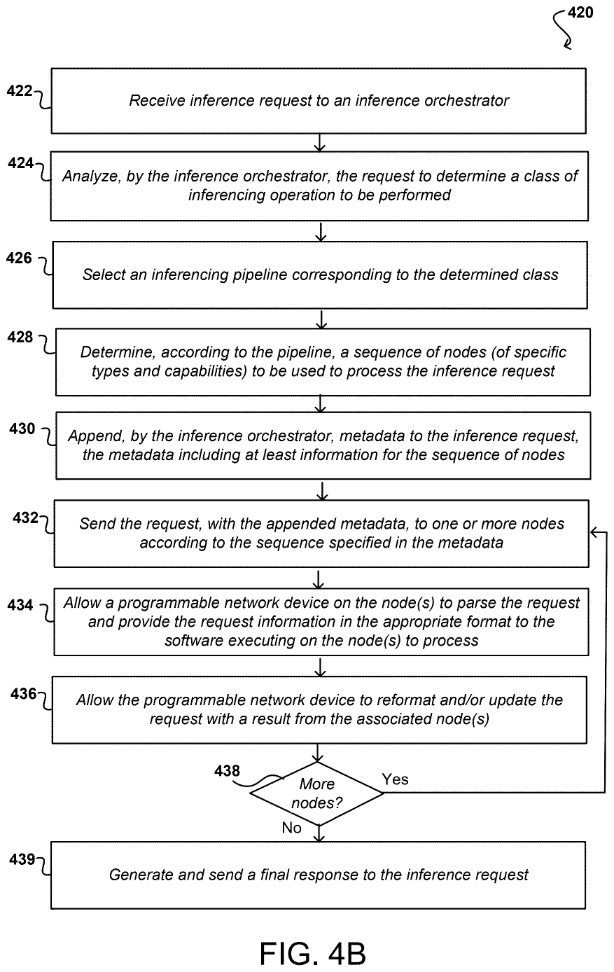

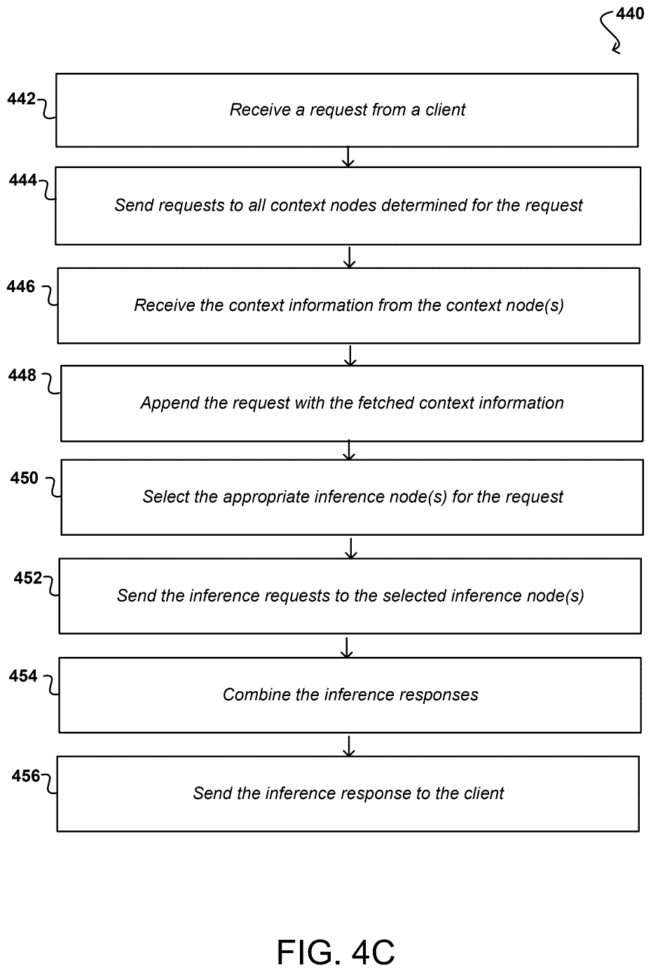

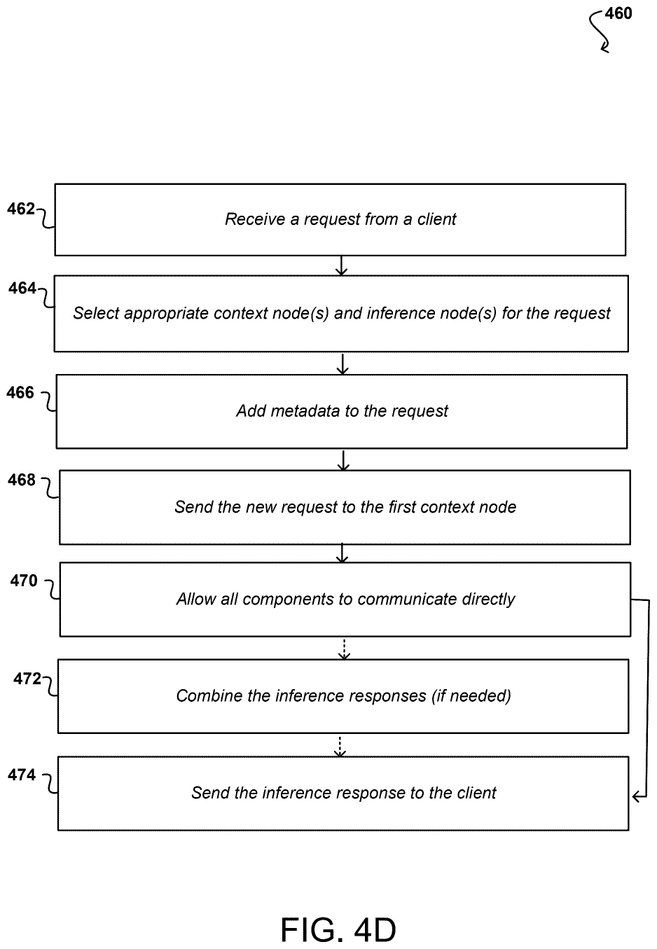

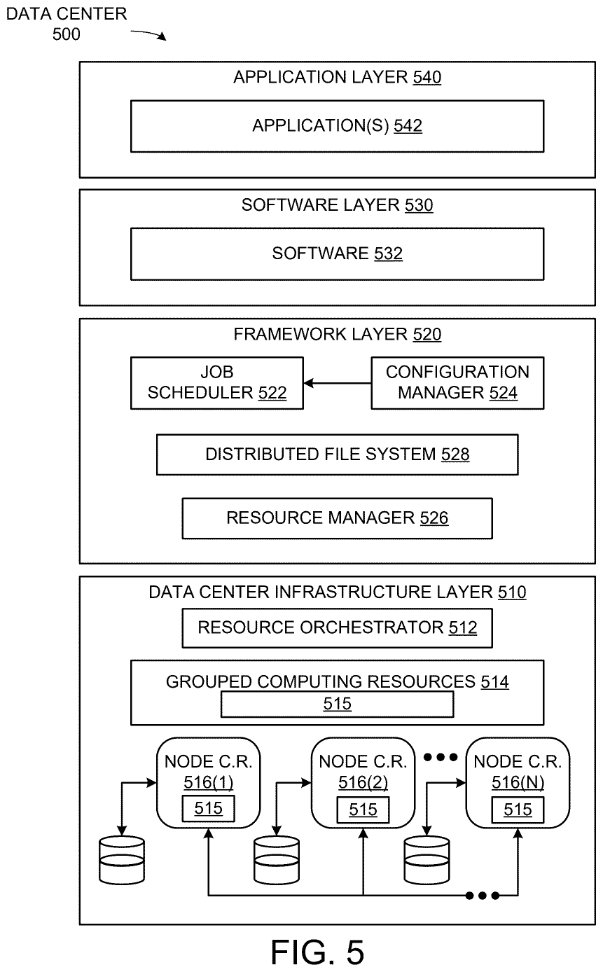

FIG. 4A illustrates an example process 400 that can be performed during an initialization phase for a set of resources, according to at least one embodiment. It should be understood that for this and other processes disclosed herein that there may be additional, fewer, or alternative steps performed in similar or alternative orders, or at least partially in parallel, within the scope of the various embodiments. Further, although this example process is discussed with respect to an inference orchestrator, and context and inference nodes, that there may be additional or alternative orchestration devices or processes, as well as additional or alternative types of nodes, used as well unless otherwise specifically stated. In this example, information is received 402, from a user, operator, or other authorized entity, that is required for deployment and orchestration of a class of inferencing operation. The information may relate to the types of nodes needed, configuration for those nodes, dependencies of those nodes, capabilities of those nodes, and the like. Such information may be received for each of a number of different classes from one or more different entities. The information can be processed 404 using an inference orchestrator in this example, which can take advantage of at least one programmable network device in at least one embodiment. The inference orchestrator can perform a number of different tasks as part of an initialization phase, and although shown here in a sequence these tasks could be performed in different orders or at least partially in parallel by one or more orchestrators, or devices in communication with an orchestrator, among other such options. There may also be many additional tasks performed other than those illustrated but within the scope of at least one embodiment. A number and type(s) of nodes (e.g., inferencing nodes, context nodes, or processing nodes) to be used for the class of operation can be determined 406, including any required capabilities of those nodes (e.g., a server with an installed NPD). A request format can be determined 408 that is to be used by all nodes, and the inference orchestrator, to parse, update, or reformat a request. An inferencing mode can be determined 410, such as whether to use centralized or distributed inferencing for a given class of inference. For example, if an inference request only requires processing with one node then even the slight additional overhead for distributed processing may be avoided by selecting for centralized processing that does not involve the addition of metadata, etc. A model can be determined 412 that is to be used for each inferencing operation in the class, as a given inference request may require multiple inferencing operations using different models. One or more applicable policies may be determined 414 for the class, as may relate to how to handle conflicts, errors, or competing results. A sequence of nodes for the class may be determined 416 according to the one or more policies. Nodes for this class can be configured 418 to perform specific types of operations, as may include loading one or more machine learning models where appropriate. The inference orchestrator, once all relevant determinations have been made, can then provide 419 a selectable pipeline for this class, and each class of inferencing operation, that an inference orchestrator an select and use in response to an inference request of the appropriate inference class.

FIG. 4B illustrates an example process 420 that can be implemented to perform orchestration for a received inference request, according to at least one embodiment. In this example, an inference request is received 422 to an inference orchestrator. The inference orchestrator can analyze 424 (or cause to be analyzed) the inference request to determine a class of inferencing to be performed. An inferencing pipeline can then be selected 426, such as one of those generated in the process of FIG. 4A, that corresponds to the determined class. A sequence of nodes can be determined 428 according to the selected pipeline, where those nodes can be of specific types and capabilities to be used to process the inferencing request. The inference orchestrator can append 430 metadata to the inference request that includes at least information for the sequence of nodes, including identifying information for the nodes. The request, with the appended metadata, can be sent 432 to one or more nodes according to the sequence specified in the metadata. For example, the request may be sent to a first context nodes, or multiple context nodes in parallel, to obtain contextual information to be used to perform inferencing for the request. A programmable network device on the node(s) receiving the request can parse the request and provide the request information in the appropriate format to relevant software executing on the respective node(s). After processing has completed, such as where contextual information has been identified by a context node or an inferencing result has been generated by an inference node, the programmable network device can be allowed 436 to reformat the request as appropriate, and can update the request with the result information from the associated node(s). It can be determined 436 whether there are more nodes in the sequence, and if so then the process can continue by sending 432 the current request to the next node(s) in the sequence. As disclosed, this request may be sent without going back to the inference orchestrator in a distributed operational mode and where the relevant node has a PND or similar capability. Once it is determined 438 that there are no more nodes in the sequence, a final response can be generated 439 and sent in response to the inference request. This response can be generated by the inference orchestrator or a capable node, and the response may be sent back to a source of the request or another appropriate recipient, among other such options.

FIG. 4C illustrates an example process 440 that can be performed for a received request using an inference orchestrator and nodes with a programmable network device or similar functionality, according to at least one embodiment. This process illustrates an example that falls within the general orchestration process 420 of FIG. 4B. In this example, a request is received 442 from a client. One or more requests can then be sent 444 to one or more context nodes determined for the request. A node might identify and fetch the relevant context through any appropriate location mechanism, such as through a vector-based search of a vector database. The context information can be received 446 back from those context nodes, and the received request can then be appended 448 (by the inference orchestrator or one of the PNDs) with the fetched context information. The appropriate inference node(s) for the request can also be selected 450. The inference requests can then be sent 452 to the selected inference nodes according to the determined sequence. The inference responses can then be combined 454 by the inference orchestrator or one of the PNDs on one of the nodes. The inference response can then be sent 456 to the client.

FIG. 4D illustrates another example process 460 that can be performed for a received request using an inference orchestrator and nodes with a programmable network device or similar functionality, according to at least one embodiment. This process illustrates another example that falls within the general orchestration process 420 of FIG. 4B. In this example process 460, a request is received 462 from a client and directed to an inference orchestrator. The appropriate context node(s) and inference node(s) can be selected 464 for the request. Metadata specifying the sequence of nodes (with node addresses), as well as other relevant information, can be added 466 to the request. The new request can be sent 468 to a first context node of the sequence, and then all components (e.g., subsequent nodes in the sequence) can be allowed 470 to communicate directly, without having to come back to the inference orchestrator unless one or more of the nodes of the sequence lack the appropriate capability. If there is more than one inference response, then the inference responses may be combined 472 (or selected) if needed, and once there is a final inference response that inference response can be sent 474 back to the client, whether by the inference orchestrator or a final node of the sequence, among other such options.

As mentioned, such approaches can help to mitigate communication overhead otherwise experienced with inference orchestration, and can help to avoid or reduce unnecessary usage of processor (e.g., CPU) capacity experience in prior CPU-based orchestration approaches. Embodiments disclosed herein can support dynamic and advanced inference pipelines, such as those that may serve multiple request classes and support a multi-node, multi-context distributed servicing system. Such a solution may exploit programmable network devices, or similar functionality, to perform orchestration and extend requests with a specific metadata format to enable entities to communicate directly without the need of sending back the requests/response to the orchestrator after each step. Such a solution can also support the scheduling and/or selection of appropriate nodes for requests and dispatch them accordingly. As mentioned, dynamic pipelines can also be used that are request-dependent, and that can support varying quality of service levels. Such an approach can also provide a network-accelerated solution that can efficiently orchestrate inference requests in various distributed settings. In at least one embodiment, an inference orchestrator can encapsulate all systems and methods required for deploying and orchestrating distributed inference operations. Such an inference orchestrator can be implemented completely or partially on programmable network devices (e.g., a DPU or NIC), with an example implementation can using one or more NVIDIA DPUs and providing a DOCA service (e.g., a DOCA LangChain service) to perform inference orchestration on the DPU(s).

### Data Center

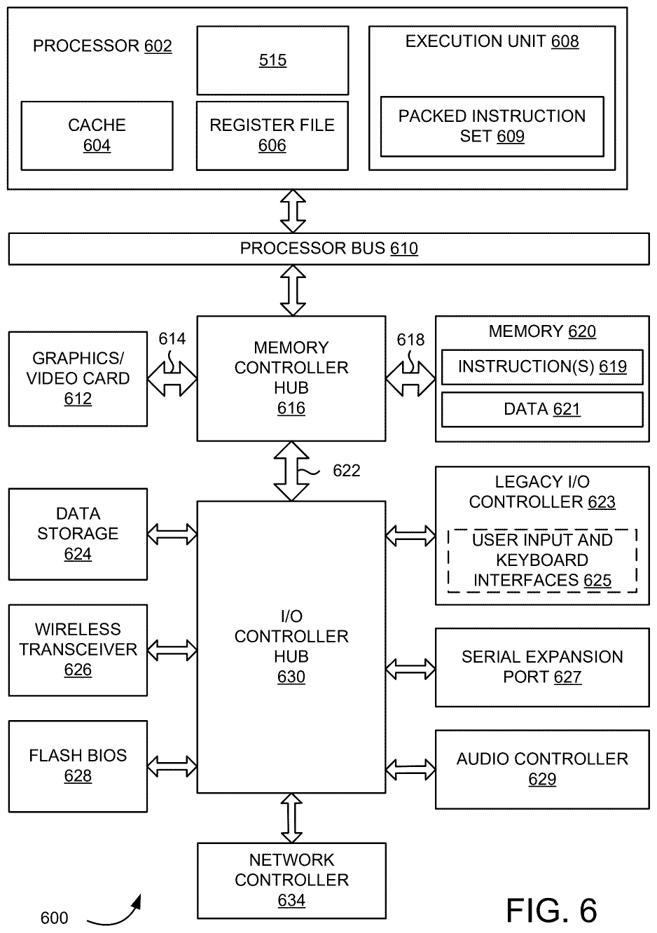

FIG. 5 illustrates an example data center 500, in which at least one embodiment may be used. In at least one embodiment, data center 500 includes a data center infrastructure layer 510, a framework layer 520, a software layer 530 and an application layer 540.

In at least one embodiment, as shown in FIG. 5, data center infrastructure layer 510 may include a resource orchestrator 512, grouped computing resources 514, and node computing resources (“node C.R.s”) 516(1)-516(N), where “N” represents a positive integer (which may be a different integer “N” than used in other figures). In at least one embodiment, node C.R.s 516(1)-516(N) may include, but are not limited to, any number of central processing units (“CPUs”) or other processors (including accelerators, field programmable gate arrays (FPGAs), graphics processors, etc.), memory storage devices 518(1)-518(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 516(1)-816(N) may be a server having one or more of above-mentioned computing resources.

In at least one embodiment, grouped computing resources 514 may include separate groupings of node C.R.s housed within one or more racks (not shown), or many racks housed in data centers at various geographical locations (also not shown). In at least one embodiment, separate groupings of node C.R.s within grouped computing resources 514 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 512 may configure or otherwise control one or more node C.R.s 516(1)-516(N) and/or grouped computing resources 514. In at least one embodiment, resource orchestrator 512 may include a software design infrastructure (“SDI”) management entity for data center 500. In at least one embodiment, resource orchestrator 512 may include hardware, software or some combination thereof.

In at least one embodiment, as shown in FIG. 5, framework layer 520 includes a job scheduler 522, a configuration manager 524, a resource manager 526 and a distributed file system 528. In at least one embodiment, framework layer 520 may include a framework to support software 532 of software layer 530 and/or one or more application(s) 542 of application layer 540. In at least one embodiment, software 532 or application(s) 542 may respectively include web-based service software or applications, such as those provided by Amazon Web Services, Google Cloud and Microsoft Azure. In at least one embodiment, framework layer 520 may be, but is not limited to, a type of free and open-source software web application framework such as Apache Spark™ (hereinafter “Spark”) that may utilize distributed file system 528 for large-scale data processing (e.g., “big data”). In at least one embodiment, job scheduler 522 may include a Spark driver to facilitate scheduling of workloads supported by various layers of data center 500. In at least one embodiment, configuration manager 524 may be capable of configuring different layers such as software layer 530 and framework layer 520 including Spark and distributed file system 528 for supporting large-scale data processing. In at least one embodiment, resource manager 526 may be capable of managing clustered or grouped computing resources mapped to or allocated for support of distributed file system 528 and job scheduler 522. In at least one embodiment, clustered or grouped computing resources may include grouped computing resources 514 at data center infrastructure layer 510. In at least one embodiment, resource manager 526 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 528 of framework layer 520. In at least one embodiment, one or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 528 of framework layer 520. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 524, resource manager 526, and resource orchestrator 512 may implement any number and type of self-modifying actions based on any amount and type of data acquired in any technically feasible fashion. In at least one embodiment, self-modifying actions may relieve a data center operator of data center 500 from making possibly bad configuration decisions and possibly avoiding underutilized and/or poor performing portions of a data center.

In at least one embodiment, data center 500 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 500. In at least one embodiment, trained machine learning models corresponding to one or more neural networks may be used to infer or predict information using resources described above with respect to data center 500 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 5 for inferencing or predicting operations based, at least in part, on weight parameters calculated using neural network training operations, neural network functions and/or architectures, or neural network use cases described herein.

Embodiments presented herein can perform inference orchestration in a distributed resource environment and allowing for network acceleration.

### Computer Systems

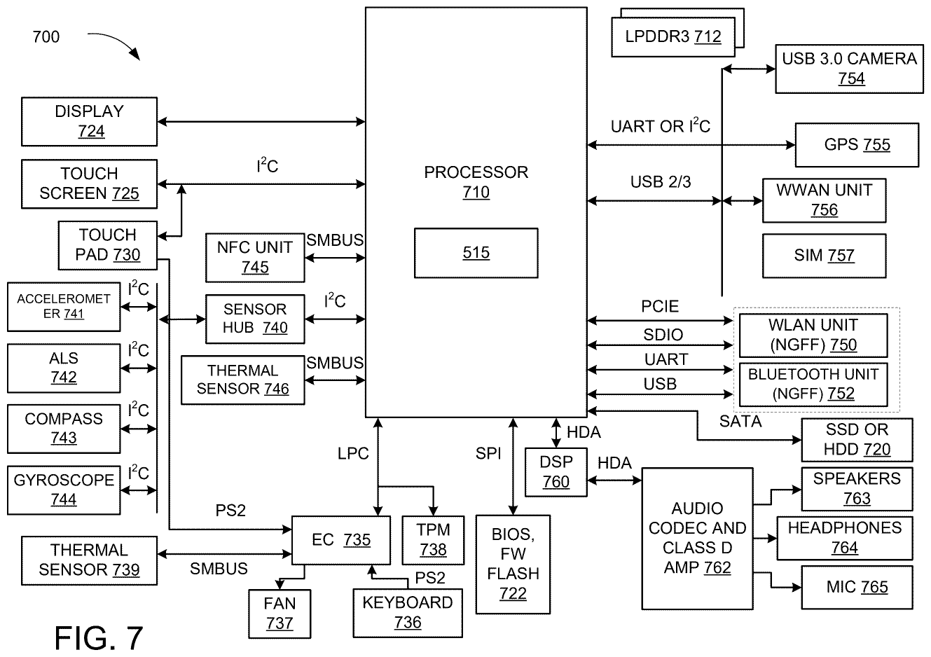

FIG. 6 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 600 may include, without limitation, a component, such as a processor 602 to employ execution units including logic to perform algorithms for process data, in accordance with present disclosure, such as in embodiment described herein. In at least one embodiment, computer system 600 may include processors, such as PENTIUM® Processor family, Xeon™, Itanium®, Scale™ and/or StrongARM™, Intel® Core™, or Intel® Nirvana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“Necks”), set-top boxes, network hubs, wide area network (“WAN”) switches, or any other system that may perform one or more instructions in accordance with at least one embodiment.

In at least one embodiment, computer system 600 may include, without limitation, processor 602 that may include, without limitation, one or more execution units 608 to perform machine learning model training and/or inferencing according to techniques described herein. In at least one embodiment, computer system 600 is a single processor desktop or server system, but in another embodiment, computer system 600 may be a multiprocessor system. In at least one embodiment, processor 602 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. Other embodiments may also include a combination of both internal and external caches depending on particular implementation and needs. In at least one embodiment, a register file 606 may store different types of data in various registers including, without limitation, integer registers, floating point registers, status registers, and an instruction pointer register.

In at least one embodiment, execution unit 608, including, without limitation, logic to perform integer and floating point operations, also resides in processor 602. In at least one embodiment, processor 602 may also include a microcode (“code”) read only memory (“ROM”) that stores microcode for certain macro instructions. In at least one embodiment, execution unit 608 may include logic to handle a packed instruction set 609. In at least one embodiment, by including packed instruction set 609 in an instruction set of a general-purpose processor, along with associated circuitry to execute instructions, operations used by many multimedia applications may be performed using packed data in processor 602. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 608 may also be used in microcontrollers, embedded processors, graphics devices, DSPs, and other types of logic circuits. In at least one embodiment, computer system 600 may include, without limitation, a memory 620. In at least one embodiment, memory 620 may be a Dynamic Random Access Memory (“DRAM”) device, a Static Random Access Memory (“SRAM”) device, a flash memory device, or another memory device. In at least one embodiment, memory 620 may store instruction(s) 619 and/or data 621 represented by data signals that may be executed by processor 602.

In at least one embodiment, a system logic chip may be coupled to processor bus 610 and memory 620. In at least one embodiment, a system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data, and textures. In at least one embodiment, MCH 616 may direct data signals between processor 602, memory 620, and other components in computer system 600 and to bridge data signals between processor bus 610, memory 620, and a system I/O interface 622. In at least one embodiment, a system logic chip may provide a graphics port for coupling to a graphics controller. In at least one embodiment, MCH 616 may be coupled to memory 620 through high bandwidth memory path 618 and a graphics/video card 612 may be coupled to MCH 616 through an Accelerated Graphics Port (“AGP”) interconnect 614.

In at least one embodiment, computer system 600 may use system I/O interface 622 as a proprietary hub interface bus to couple MCH 616 to an I/O controller hub (“ICH”) 630. In at least one embodiment, ICH 630 may provide direct connections to some I/O devices via a local I/O bus. In at least one embodiment, a local I/O bus may include, without limitation, a high-speed I/O bus for connecting peripherals to memory 620, a chipset, and processor 602. Examples may include, without limitation, an audio controller 629, a firmware hub (“flash BIOS”) 628, a wireless transceiver 626, a data storage 624, a legacy I/O controller 623 containing user input and keyboard interfaces 625, a serial expansion port 627, such as a Universal Serial Bus (“USB”) port, and a network controller 634. In at least one embodiment, data storage 624 may comprise a hard disk drive, a floppy disk drive, a CD-ROM device, a flash memory device, or other mass storage device.

In at least one embodiment, FIG. 6 illustrates a system, which includes interconnected hardware devices or “chips”, whereas in other embodiments, FIG. 6 may illustrate an exemplary SoC In at least one embodiment, devices illustrated in FIG. 6 may be interconnected with proprietary interconnects, standardized interconnects (e.g., PCIe) or some combination thereof. In at least one embodiment, one or more components of computer system 600 are interconnected using compute express link (CXL) interconnects.

Inference and/or training logic 515 are used to perform inferencing and/or training operations associated with one or more embodiments. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Embodiments presented herein can perform inference orchestration in a distributed resource environment and allowing for network acceleration.

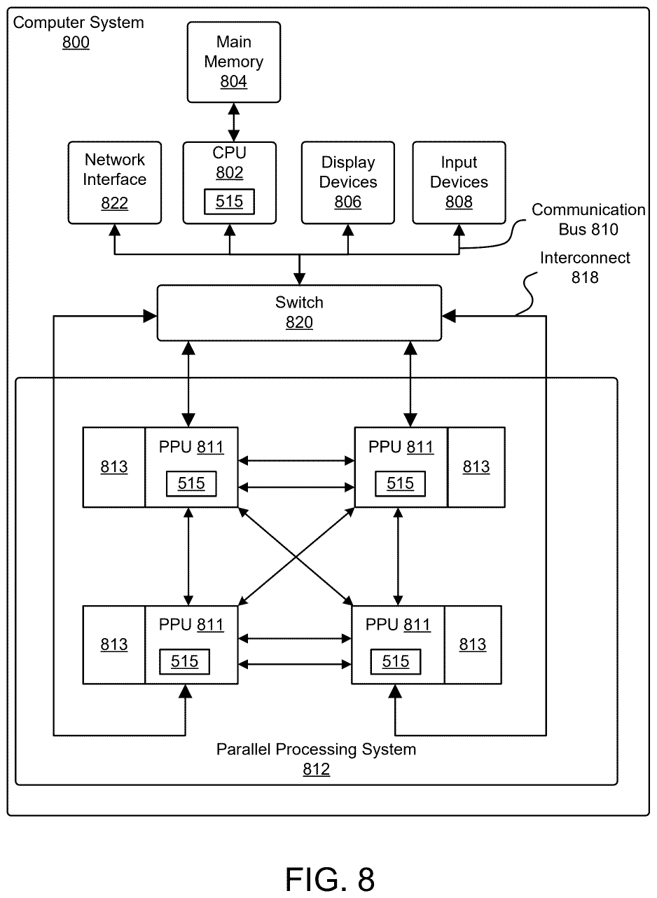

FIG. 7 is a block diagram illustrating an electronic device 700 for utilizing a processor 710, according to at least one embodiment. In at least one embodiment, electronic device 700 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 700 may include, without limitation, processor 710 communicatively coupled to any suitable number or kind of components, peripherals, modules, or devices. In at least one embodiment, processor 710 is coupled using a bus or interface, such as a I²C bus, a System Management Bus (“Sambas”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of FIG. 7 are interconnected using compute express link (CXL) interconnects.

In at least one embodiment, FIG. 7 may include a display 724, a touch screen 725, a touch pad 730, a Near Field Communications unit (“NFC”) 745, a sensor hub 740, a thermal sensor 746, an Express Chipset (“EC”) 735, a Trusted Platform Module (“TPM”) 738, BIOS/firmware/flash memory (“BIOS, FW Flash”) 722, a DSP 760, a drive 720 such as a Solid State Disk (“SSD”) or a Hard Disk Drive (“HDD”), a wireless local area network unit (“WLAN”) 750, a Bluetooth unit 752, a Wireless Wide Area Network unit (“WWAN”) 756, a Global Positioning System (GPS) unit 755, a camera (“USB 3.0 camera”) 754 such as a USB 3.0 camera, and/or a Low Power Double Data Rate (“LPDDR”) memory unit (“LPDDR3”) 715 implemented in, for example, an LPDDR3 standard. These components may each be implemented in any suitable manner.

In at least one embodiment, other components may be communicatively coupled to processor 710 through components described herein. In at least one embodiment, an accelerometer 741, an ambient light sensor (“ALS”) 742, a compass 743, and a gyroscope 744 may be communicatively coupled to sensor hub 740. In at least one embodiment, a thermal sensor 739, a fan 737, a keyboard 736, and touch pad 730 may be communicatively coupled to EC 735. In at least one embodiment, speakers 763, headphones 764, and a microphone (“mic”) 765 may be communicatively coupled to an audio unit (“audio codec and class D amp”) 762, which may in turn be communicatively coupled to DSP 760. In at least one embodiment, audio unit 762 may include, for example and without limitation, an audio coder/decoder (“codec”) and a class D amplifier. In at least one embodiment, a SIM card (“SIM”) 757 may be communicatively coupled to WWAN unit 756. In at least one embodiment, components such as WLAN unit 750 and Bluetooth unit 752, as well as WWAN unit 756 may be implemented in a Next Generation Form Factor (“NGFF”).

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

Embodiments presented herein can perform inference orchestration in a distributed resource environment and allowing for network acceleration.

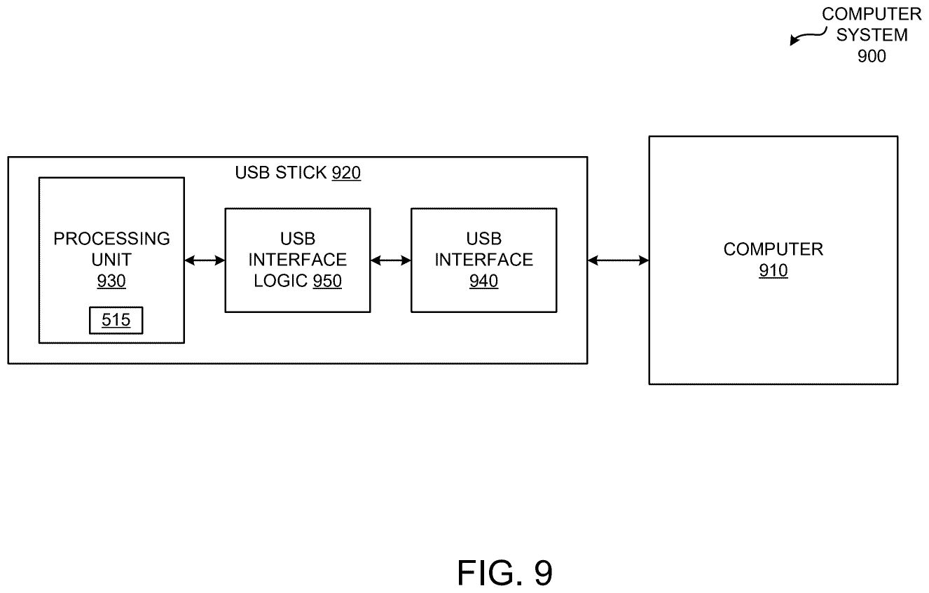

FIG. 8 illustrates a computer system 800, according to at least one embodiment. In at least one embodiment, computer system 800 is configured to implement various processes and methods described throughout this disclosure.

In at least one embodiment, computer system 800 comprises, without limitation, at least one central processing unit (“CPU”) 802 that is connected to a communication bus 810 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 800 includes, without limitation, a main memory 804 and control logic (e.g., implemented as hardware, software, or a combination thereof) and data are stored in main memory 804, which may take form of random access memory (“RAM”). In at least one embodiment, a network interface subsystem (“network interface”) 822 provides an interface to other computing devices and networks for receiving data from and transmitting data to other systems with computer system 800.

In at least one embodiment, computer system 800, in at least one embodiment, includes, without limitation, input devices 808, a parallel processing system 812, and display devices 806 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 808 such as keyboard, mouse, touchpad, microphone, etc. In at least one embodiment, each module described herein can be situated on a single semiconductor platform to form a processing system.

Inference and/or training logic 515 are used to perform inferencing and/or training operations associated with one or more embodiments. In at least one embodiment, inference and/or training logic 515 may be used in system FIG. 8 for inferencing or predicting operations based, at least in part, on weight parameters calculated using neural network training operations, neural network functions and/or architectures, or neural network use cases described herein.

Embodiments presented herein can perform inference orchestration in a distributed resource environment and allowing for network acceleration.

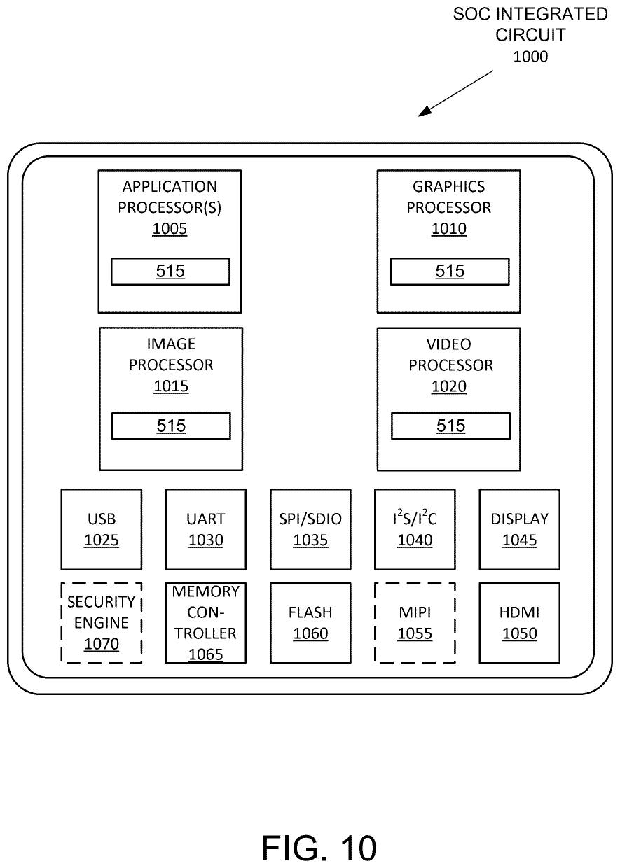

FIG. 9 illustrates a computer system 900, according to at least one embodiment. In at least one embodiment, computer system 900 includes, without limitation, a computer 910 and a USB stick 920. In at least one embodiment, computer 910 may include, without limitation, any number and type of processor(s) (not shown) and a memory (not shown). In at least one embodiment, computer 910 includes, without limitation, a server, a cloud instance, a laptop, and a desktop computer.

In at least one embodiment, USB stick 920 includes, without limitation, a processing unit 930, a USB interface 940, and USB interface logic 950. In at least one embodiment, processing unit 930 may be any instruction execution system, apparatus, or device capable of executing instructions. In at least one embodiment, processing unit 930 may include, without limitation, any number and type of processing cores (not shown). In at least one embodiment, processing unit 930 comprises an application specific integrated circuit (“ASIC”) that is optimized to perform any amount and type of operations associated with machine learning. For instance, in at least one embodiment, processing unit 930 is a tensor processing unit (“TPC”) that is optimized to perform machine learning inference operations. In at least one embodiment, processing unit 930 is a vision processing unit (“VPU”) that is optimized to perform machine vision and machine learning inference operations.

In at least one embodiment, USB interface 940 may be any type of USB connector or USB socket. For instance, in at least one embodiment, USB interface 940 is a USB 3.0 Type-C socket for data and power. In at least one embodiment, USB interface 940 is a USB 3.0 Type-A connector. In at least one embodiment, USB interface logic 950 may include any amount and type of logic that enables processing unit 930 to interface with devices (e.g., computer 910) via USB connector 940.

Inference and/or training logic 515 are used to perform inferencing and/or training operations associated with one or more embodiments. In at least one embodiment, inference and/or training logic 515 may be used in system FIG. 9 for inferencing or predicting operations based, at least in part, on weight parameters calculated using neural network training operations, neural network functions and/or architectures, or neural network use cases described herein.

Embodiments presented herein can perform inference orchestration in a distributed resource environment and allowing for network acceleration.

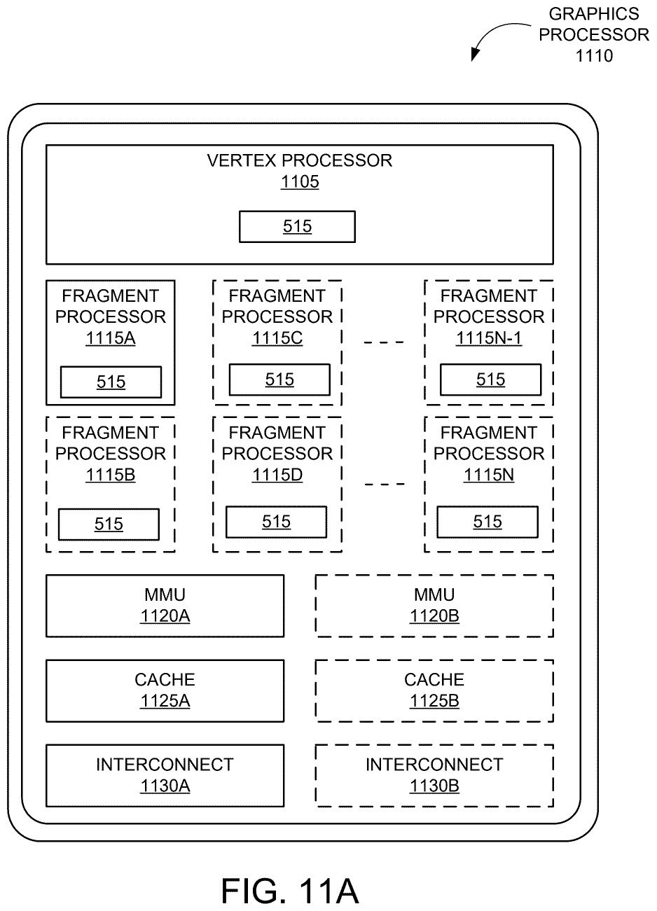

FIG. 10 illustrates exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIG. 10 is a block diagram illustrating an exemplary system-on-a-chip (SOC) integrated circuit 1000 that may be fabricated using one or more IP cores, according to at least one embodiment. In at least one embodiment, SOC integrated circuit 1000 includes one or more application processor(s) 1005 (e.g., CPUs), at least one graphics processor 1010, and may additionally include an image processor 1015 and/or a video processor 1020, any of which may be a modular IP core. In at least one embodiment, SOC integrated circuit 1000 includes peripheral or bus logic including a USB controller 1025, a UART controller 1030, an SPI/SDIO controller 1035, and an I²2S/I²2C controller 1040. In at least one embodiment, SOC integrated circuit 1000 can include a display device 1045 coupled to one or more of a high-definition multimedia interface (HDMI) controller 1050 and a mobile industry processor interface (MIPI) display interface 1055. In at least one embodiment, storage may be provided by a flash memory subsystem 1060 including flash memory and a flash memory controller. In at least one embodiment, a memory interface may be provided via a memory controller 1065 for access to SDRAM or SRAM memory devices. In at least one embodiment, some integrated circuits additionally include an embedded security engine 1070.

Inference and/or training logic 515 are used to perform inferencing and/or training operations associated with one or more embodiments. In at least one embodiment, inference and/or training logic 515 may be used in SOC integrated circuit 1000 for inferencing or predicting operations based, at least in part, on weight parameters calculated using neural network training operations, neural network functions and/or architectures, or neural network use cases described herein.

Embodiments presented herein can perform inference orchestration in a distributed resource environment and allowing for network acceleration.

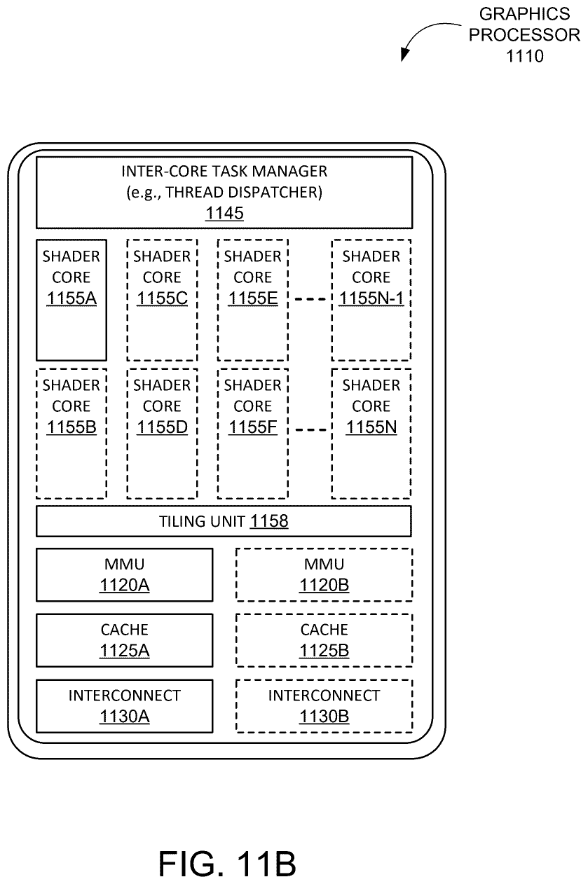

FIGS. 11A-11B illustrate exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIGS. 11A-11B are block diagrams illustrating exemplary graphics processors for use within an SoC, according to embodiments described herein. FIG. 11A illustrates an exemplary graphics processor 1110 of a system on a chip integrated circuit that may be fabricated using one or more IP cores, according to at least one embodiment. FIG. 11B illustrates an additional exemplary graphics processor 1140 of a system on a chip integrated circuit that may be fabricated using one or more IP cores, according to at least one embodiment. In at least one embodiment, graphics processor 1110 of FIG. 11A is a low power graphics processor core. In at least one embodiment, graphics processor 1140 of FIG. 11B is a higher performance graphics processor core. In at least one embodiment, each of graphics processors 1110, 1140 can be variants of computer system 900 of FIG. 9.

In at least one embodiment, graphics processor 1110 includes a vertex processor 1105 and one or more fragment processor(s) 1115A-1115N (e.g., 1115A, 1115B, 1115C, 1115D, through 1115N-1, and 1115N). In at least one embodiment, graphics processor 1110 can execute different shader programs via separate logic, such that vertex processor 1105 is optimized to execute operations for vertex shader programs, while one or more fragment processor(s) 1115A-1115N execute fragment (e.g., pixel) shading operations for fragment or pixel shader programs. In at least one embodiment, vertex processor 1105 performs a vertex processing stage of a 3D graphics pipeline and generates primitives and vertex data. In at least one embodiment, fragment processor(s) 1115A-1115N use primitive and vertex data generated by vertex processor 1105 to produce a framebuffer that is displayed on a display device. In at least one embodiment, fragment processor(s) 1115A-1115N are optimized to execute fragment shader programs as provided for in an OpenGL API, which may be used to perform similar operations as a pixel shader program as provided for in a Direct 3D API.

In at least one embodiment, graphics processor 1110 additionally includes one or more memory management units (MMUs) 1120A-1120B, cache(s) 1125A-1125B, and circuit interconnect(s) 1130A-1130B. In at least one embodiment, one or more MMU(s) 1120A-1120B provide for virtual to physical address mapping for graphics processor 1110, including for vertex processor 1105 and/or fragment processor(s) 1115A-1115N, which may reference vertex or image/texture data stored in memory, in addition to vertex or image/texture data stored in one or more cache(s) 1125A-1125B. In at least one embodiment, one or more MMU(s) 1120A-1120B may be synchronized with other MMUs within a system, including one or more MMUs associated with one or more application processor(s) 1105, image processors 1115, and/or video processors 1120 of FIG. 11A, such that each processor 1105-1120 can participate in a shared or unified virtual memory system. In at least one embodiment, one or more circuit interconnect(s) 1130A-1130B enable graphics processor 1110 to interface with other IP cores within SoC, either via an internal bus of SoC or via a direct connection.

In at least one embodiment, graphics processor 1140 includes one or more shader core(s) 1155A-1155N (e.g., 1155A, 1155B, 1155C, 1155D, 1155E, 1155F, through 1155N-1, and 1155N) as shown in FIG. 11B, which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 1140 includes an inter-core task manager 1145, which acts as a thread dispatcher to dispatch execution threads to one or more shader cores 1155A-1155N and a tiling unit 1158 to accelerate tiling operations for tile-based rendering, in which rendering operations for a scene are subdivided in image space, for example to exploit local spatial coherence within a scene or to optimize use of internal caches.

Embodiments presented herein can perform inference orchestration in a distributed resource environment and allowing for network acceleration.

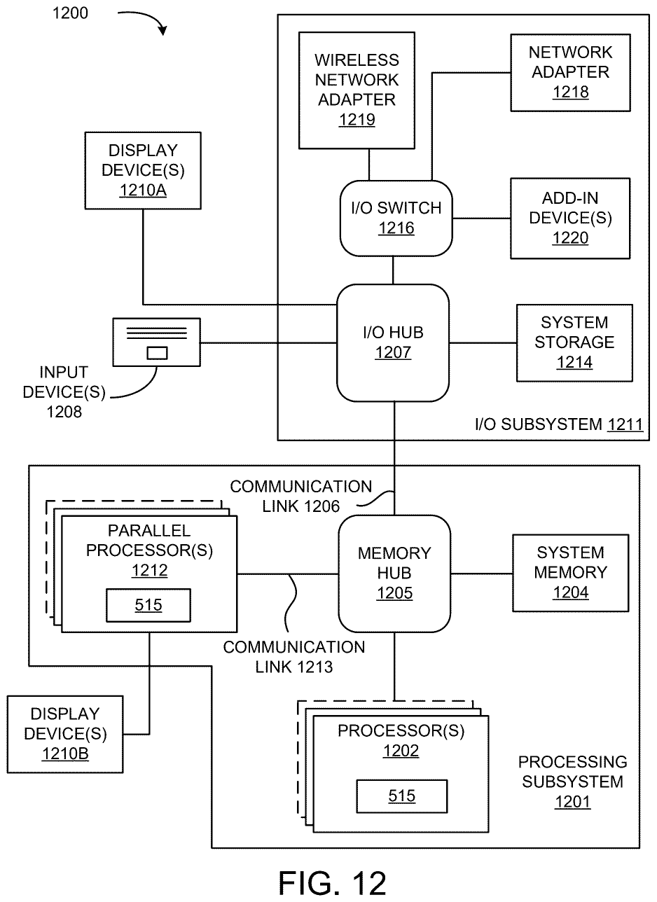

FIG. 12 is a block diagram illustrating a computing system 1200 according to at least one embodiment. In at least one embodiment, computing system 1200 includes a processing subsystem 1201 having one or more processor(s) 1202 and a system memory 1204 communicating via an interconnection path that may include a memory hub 1205. In at least one embodiment, memory hub 1205 may be a separate component within a chipset component or may be integrated within one or more processor(s) 1202. In at least one embodiment, memory hub 1205 couples with an I/O subsystem 1211 via a communication link 1206. In at least one embodiment, I/O subsystem 1211 includes an I/O hub 1207 that can enable computing system 1200 to receive input from one or more input device(s) 1208. In at least one embodiment, I/O hub 1207 can enable a display controller, which may be included in one or more processor(s) 1202, to provide outputs to one or more display device(s) 1210A. In at least one embodiment, one or more display device(s) 1210A coupled with I/O hub 1207 can include a local, internal, or embedded display device.

In at least one embodiment, processing subsystem 1201 includes one or more parallel processor(s) 1212 coupled to memory hub 1205 via a bus or other communication link 1213. In at least one embodiment, communication link 1213 may use one of any number of standards based communication link technologies or protocols, such as but not limited to PCI Express, or may be a vendor-specific communications interface or communications fabric. In at least one embodiment, one or more parallel processor(s) 1212 form a computationally focused parallel or vector processing system that can include a large number of processing cores and/or processing clusters, such as a many-integrated core (MIC) processor. In at least one embodiment, some or all of parallel processor(s) 1212 form a graphics processing subsystem that can output pixels to one of one or more display device(s) 1210A coupled via I/O hub 1207. In at least one embodiment, parallel processor(s) 1212 can also include a display controller and display interface (not shown) to enable a direct connection to one or more display device(s) 1210B. In at least one embodiment, parallel processor(s) 1212 include one or more cores, such as graphics cores 1200 discussed herein.

In at least one embodiment, a system storage unit 1214 can connect to I/O hub 1207 to provide a storage mechanism for computing system 1200. In at least one embodiment, an I/O switch 1216 can be used to provide an interface mechanism to enable connections between I/O hub 1207 and other components, such as a network adapter 1218 and/or a wireless network adapter 1219 that may be integrated into platform, and various other devices that can be added via one or more add-in device(s) 1220. In at least one embodiment, network adapter 1218 can be an Ethernet adapter or another wired network adapter. In at least one embodiment, wireless network adapter 1219 can include one or more of a Wi-Fi, Bluetooth, near field communication (NFC), or other network device that includes one or more wireless radios.

In at least one embodiment, computing system 1200 can include other components not explicitly shown, including USB or other port connections, optical storage drives, video capture devices, and like, may also be connected to I/O hub 1207. In at least one embodiment, communication paths interconnecting various components in FIG. 12 may be implemented using any suitable protocols, such as PCI (Peripheral Component Interconnect) based protocols (e.g., PCI-Express), or other bus or point-to-point communication interfaces and/or protocol(s), such as NV-Link high-speed interconnect, or interconnect protocols.

In at least one embodiment, parallel processor(s) 1212 incorporate circuitry optimized for graphics and video processing, including, for example, video output circuitry, and constitutes a graphics processing unit (GPU), e.g., parallel processor(s) 1212 includes graphics core 1200. In at least one embodiment, parallel processor(s) 1212 incorporate circuitry optimized for general purpose processing. In at least embodiment, components of computing system 1200 may be integrated with one or more other system elements on a single integrated circuit. For example, in at least one embodiment, parallel processor(s) 1212, memory hub 1205, processor(s) 1202, and I/O hub 1207 can be integrated into a system on chip (SoC) integrated circuit. In at least one embodiment, components of computing system 1200 can be integrated into a single package to form a system in package (SIP) configuration. In at least one embodiment, at least a portion of components of computing system 1200 can be integrated into a multi-chip module (MCM), which can be interconnected with other multi-chip modules into a modular computing system.

Inference and/or training logic 515 are used to perform inferencing and/or training operations associated with one or more embodiments. In at least one embodiment, inference and/or training logic 515 may be used in system FIG. 12 for inferencing or predicting operations based, at least in part, on weight parameters calculated using neural network training operations, neural network functions and/or architectures, or neural network use cases described herein.

Embodiments presented herein can perform inference orchestration in a distributed resource environment and allowing for network acceleration.

### Processors

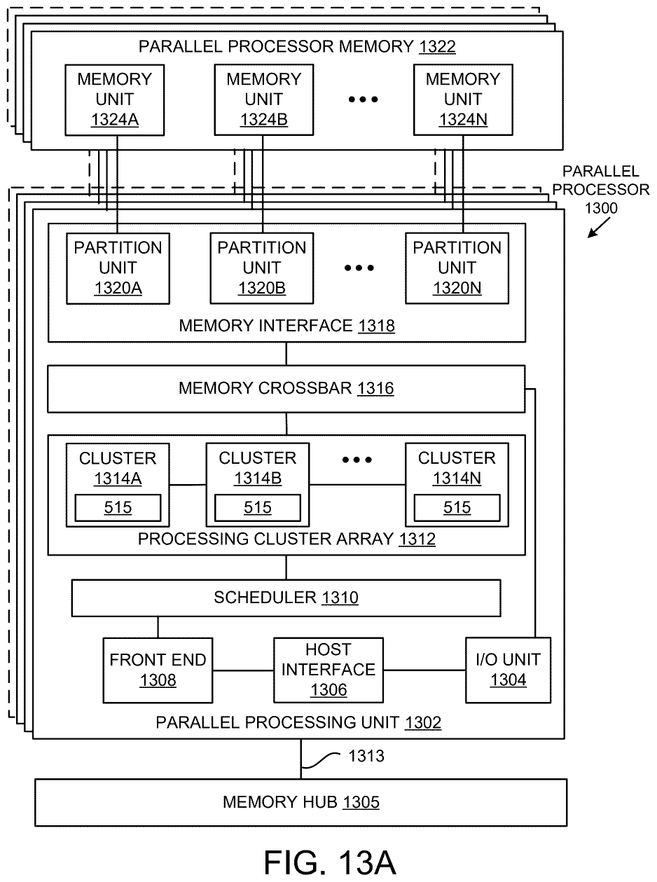

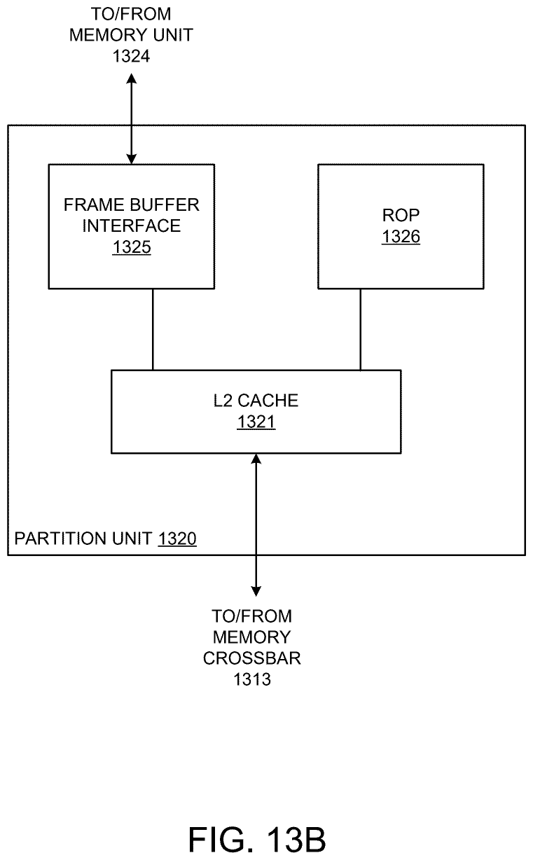

FIG. 13A illustrates a parallel processor 1300 according to at least one embodiment. In at least one embodiment, various components of parallel processor 1300 may be implemented using one or more integrated circuit devices, such as programmable processors, application specific integrated circuits (ASICs), or field programmable gate arrays (FPGA). In at least one embodiment, illustrated parallel processor 1300 is a variant of one or more parallel processor(s) 1212 shown in FIG. 12 according to an exemplary embodiment. In at least one embodiment, a parallel processor 1300 includes one or more graphics cores 1200.

In at least one embodiment, parallel processor 1300 includes a parallel processing unit 1302. In at least one embodiment, parallel processing unit 1302 includes an I/O unit 1304 that enables communication with other devices, including other instances of parallel processing unit 1302. In at least one embodiment, I/O unit 1304 may be directly connected to other devices. In at least one embodiment, I/O unit 1304 connects with other devices via use of a hub or switch interface, such as a memory hub 1305. In at least one embodiment, connections between memory hub 1305 and I/O unit 1304 form a communication link 1313. In at least one embodiment, I/O unit 1304 connects with a host interface 1306 and a memory crossbar 1313, where host interface 1306 receives commands directed to performing processing operations and memory crossbar 1316 receives commands directed to performing memory operations.

In at least one embodiment, when host interface 1306 receives a command buffer via I/O unit 1304, host interface 1306 can direct work operations to perform those commands to a front end 1308. In at least one embodiment, front end 1308 couples with a scheduler 1310 (which may be referred to as a sequencer), which is configured to distribute commands or other work items to a processing cluster array 1312. In at least one embodiment, scheduler 1310 ensures that processing cluster array 1312 is properly configured and in a valid state before tasks are distributed to a cluster of processing cluster array 1312. In at least one embodiment, scheduler 1310 is implemented via firmware logic executing on a microcontroller. In at least one embodiment, microcontroller implemented scheduler 1310 is configurable to perform complex scheduling and work distribution operations at coarse and fine granularity, enabling rapid preemption and context switching of threads executing on processing array 1312. In at least one embodiment, host software can prove workloads for scheduling on processing cluster array 1312 via one of multiple graphics processing paths. In at least one embodiment, workloads can then be automatically distributed across processing array cluster 1312 by scheduler 1310 logic within a microcontroller including scheduler 1310.

In at least one embodiment, processing cluster array 1312 can include up to “N” processing clusters (e.g., cluster 1314A, cluster 1314B, through cluster 1314N), where “N” represents a positive integer (which may be a different integer “N” than used in other figures). In at least one embodiment, each cluster 1314A-1314N of processing cluster array 1312 can execute a large number of concurrent threads. In at least one embodiment, scheduler 1310 can allocate work to clusters 1314A-1314N of processing cluster array 1312 using various scheduling and/or work distribution algorithms, which may vary depending on workload arising for each type of program or computation. In at least one embodiment, scheduling can be handled dynamically by scheduler 1310, or can be assisted in part by compiler logic during compilation of program logic configured for execution by processing cluster array 1312. In at least one embodiment, different clusters 1314A-1314N of processing cluster array 1312 can be allocated for processing different types of programs or for performing different types of computations.

In at least one embodiment, processing cluster array 1312 can be configured to perform various types of parallel processing operations. In at least one embodiment, processing cluster array 1312 is configured to perform general-purpose parallel compute operations. For example, in at least one embodiment, processing cluster array 1312 can include logic to execute processing tasks including filtering of video and/or audio data, performing modeling operations, including physics operations, and performing data transformations.

In at least one embodiment, processing cluster array 1312 is configured to perform parallel graphics processing operations. In at least one embodiment, processing cluster array 1312 can include additional logic to support execution of such graphics processing operations, including but not limited to, texture sampling logic to perform texture operations, as well as tessellation logic and other vertex processing logic. In at least one embodiment, processing cluster array 1312 can be configured to execute graphics processing related shader programs such as but not limited to, vertex shaders, tessellation shaders, geometry shaders, and pixel shaders. In at least one embodiment, parallel processing unit 1302 can transfer data from system memory via I/O unit 1304 for processing. In at least one embodiment, during processing, transferred data can be stored to on-chip memory (e.g., parallel processor memory 1322) during processing, then written back to system memory.

In at least one embodiment, when parallel processing unit 1302 is used to perform graphics processing, scheduler 1310 can be configured to divide a processing workload into approximately equal sized tasks, to better enable distribution of graphics processing operations to multiple clusters 1314A-1314N of processing cluster array 1312. In at least one embodiment, portions of processing cluster array 1312 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1314A-1314N may be stored in buffers to allow intermediate data to be transmitted between clusters 1314A-1314N for further processing.

In at least one embodiment, processing cluster array 1312 can receive processing tasks to be executed via scheduler 1310, which receives commands defining processing tasks from front end 1308. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1310 may be configured to fetch indices corresponding to tasks or may receive indices from front end 1308. In at least one embodiment, front end 1308 can be configured to ensure processing cluster array 1312 is configured to a valid state before a workload specified by incoming command buffers (e.g., batch-buffers, push buffers, etc.) is initiated.

In at least one embodiment, each of one or more instances of parallel processing unit 1302 can couple with a parallel processor memory 1322. In at least one embodiment, parallel processor memory 1322 can be accessed via memory crossbar 1316, which can receive memory requests from processing cluster array 1312 as well as I/O unit 1304. In at least one embodiment, memory crossbar 1316 can access parallel processor memory 1322 via a memory interface 1318. In at least one embodiment, memory interface 1318 can include multiple partition units (e.g., partition unit 1320A, partition unit 1320B, through partition unit 1320N) that can each couple to a portion (e.g., memory unit) of parallel processor memory 1322. In at least one embodiment, a number of partition units 1320A-1320N is configured to be equal to a number of memory units, such that a first partition unit 1320A has a corresponding first memory unit 1324A, a second partition unit 1320B has a corresponding memory unit 1324B, and an N-th partition unit 1320N has a corresponding N-th memory unit 1324N. In at least one embodiment, a number of partition units 1320A-1320N may not be equal to a number of memory units.

In at least one embodiment, memory units 1324A-1324N can include various types of memory devices, including dynamic random access memory (DRAM) or graphics random access memory, such as synchronous graphics random access memory (SGRAM), including graphics double data rate (GDDR) memory. In at least one embodiment, memory units 1324A-1324N may also include 3D stacked memory, including but not limited to high bandwidth memory (HBM), HBM2e, or HDM3. In at least one embodiment, render targets, such as frame buffers or texture maps may be stored across memory units 1324A-1324N, allowing partition units 1320A-1320N to write portions of each render target in parallel to efficiently use available bandwidth of parallel processor memory 1322. In at least one embodiment, a local instance of parallel processor memory 1322 may be excluded in favor of a unified memory design that utilizes system memory in conjunction with local cache memory.

In at least one embodiment, any one of clusters 1314A-1314N of processing cluster array 1312 can process data that will be written to any of memory units 1324A-1324N within parallel processor memory 1322. In at least one embodiment, memory crossbar 1316 can be configured to transfer an output of each cluster 1314A-1314N to any partition unit 1320A-1320N or to another cluster 1314A-1314N, which can perform additional processing operations on an output. In at least one embodiment, each cluster 1314A-1314N can communicate with memory interface 1318 through memory crossbar 1316 to read from or write to various external memory devices. In at least one embodiment, memory crossbar 1316 has a connection to memory interface 1318 to communicate with I/O unit 1304, as well as a connection to a local instance of parallel processor memory 1322, enabling processing units within different processing clusters 1314A-1314N to communicate with system memory or other memory that is not local to parallel processing unit 1302. In at least one embodiment, memory crossbar 1316 can use virtual channels to separate traffic streams between clusters 1314A-1314N and partition units 1320A-1320N.

In at least one embodiment, multiple instances of parallel processing unit 1302 can be provided on a single add-in card, or multiple add-in cards can be interconnected. In at least one embodiment, different instances of parallel processing unit 1302 can be configured to interoperate even if different instances have different numbers of processing cores, different amounts of local parallel processor memory, and/or other configuration differences. For example, in at least one embodiment, some instances of parallel processing unit 1302 can include higher precision floating point units relative to other instances. In at least one embodiment, systems incorporating one or more instances of parallel processing unit 1302 or parallel processor 1300 can be implemented in a variety of configurations and form factors, including but not limited to desktop, laptop, or handheld personal computers, servers, workstations, game consoles, and/or embedded systems.

FIG. 13B is a block diagram of a partition unit 1320 according to at least one embodiment. In at least one embodiment, partition unit 1320 is an instance of one of partition units 1320A-1320N of FIG. 13A. In at least one embodiment, partition unit 1320 includes an L2 cache 1321, a frame buffer interface 1325, and a ROP 1326 (raster operations unit). In at least one embodiment, L2 cache 1321 is a read/write cache that is configured to perform load and store operations received from memory crossbar 1316 and ROP 1326. In at least one embodiment, read misses and urgent write-back requests are output by L2 cache 1321 to frame buffer interface 1325 for processing. In at least one embodiment, updates can also be sent to a frame buffer via frame buffer interface 1325 for processing. In at least one embodiment, frame buffer interface 1325 interfaces with one of memory units in parallel processor memory, such as memory units 1324A-1324N of FIG. 13A (e.g., within parallel processor memory 1322).

In at least one embodiment, ROP 1326 is a processing unit that performs raster operations such as stencil, z test, blending, etc. In at least one embodiment, ROP 1326 then outputs processed graphics data that is stored in graphics memory. In at least one embodiment, ROP 1326 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1326 can vary based on statistical characteristics of data to be compressed. For example, in at least one embodiment, delta color compression is performed on depth and color data on a per-tile basis.

In at least one embodiment, ROP 1326 is included within each processing cluster (e.g., cluster 1314A-1314N of FIG. 13A) instead of within partition unit 1320. In at least one embodiment, read and write requests for pixel data are transmitted over memory crossbar 1316 instead of pixel fragment data. In at least one embodiment, processed graphics data may be displayed on a display device, such as one of one or more display device(s) 1510 of FIG. 15, routed for further processing by processor(s) 1302, or routed for further processing by one of processing entities within parallel processor 1300 of FIG. 13A.

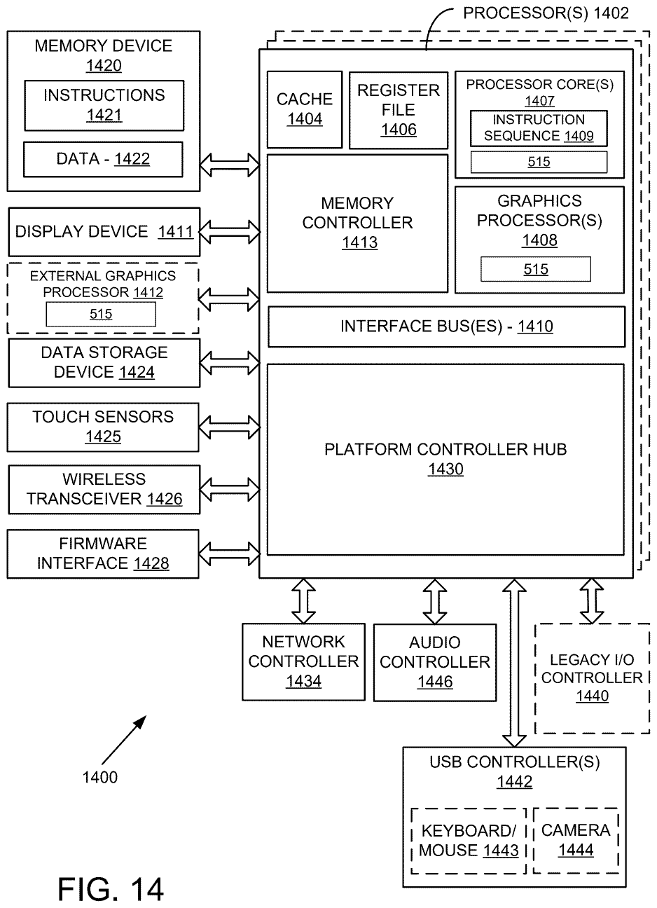

FIG. 14 is a block diagram of a processing system, according to at least one embodiment. In at least one embodiment, system 1400 includes one or more processor(s) 1402 and one or more graphics processor(s) 1408, and may be a single processor desktop system, a multiprocessor workstation system, or a server system having a large number of processor(s) 1402 or processor core(s) 1407. In at least one embodiment, system 1400 is a processing platform incorporated within a system-on-a-chip (SoC) integrated circuit for use in mobile, handheld, or embedded devices. In at least one embodiment, one or more graphics processor(s) 1408 include one or more graphics cores 1200.

In at least one embodiment, system 1400 can include, or be incorporated within a server-based gaming platform, a game console, including a game and media console, a mobile gaming console, a handheld game console, or an online game console. In at least one embodiment, system 1400 is a mobile phone, a smart phone, a tablet computing device or a mobile Internet device. In at least one embodiment, processing system 1400 can also include, couple with, or be integrated within a wearable device, such as a smart watch wearable device, a smart eyewear device, an augmented reality device, or a virtual reality device. In at least one embodiment, processing system 1400 is a television or set top box device having one or more processor(s) 1402 and a graphical interface generated by one or more graphics processor(s) 1408.

In at least one embodiment, one or more processor(s) 1402 each include one or more processor core(s) 1407 to process instructions which, when executed, perform operations for system and user software. In at least one embodiment, each of one or more processor core(s) 1407 is configured to process a specific instruction sequence 1409. In at least one embodiment, instruction sequence 1409 may facilitate Complex Instruction Set Computing (CISC), Reduced Instruction Set Computing (RISC), or computing via a Very Long Instruction Word (VLIW). In at least one embodiment, processor core(s) 1407 may each process a different instruction sequence 1409, which may include instructions to facilitate emulation of other instruction sequences. In at least one embodiment, processor core(s) 1407 may also include other processing devices, such a Digital Signal Processor (DSP).

In at least one embodiment, processor(s) 1402 includes a cache memory 1404. In at least one embodiment, processor(s) 1402 can have a single internal cache or multiple levels of internal cache. In at least one embodiment, cache memory is shared among various components of processor(s) 1402. In at least one embodiment, processor(s) 1402 also uses an external cache (e.g., a Level-3 (L3) cache or Last Level Cache (LLC)) (not shown), which may be shared among processor core(s) 1407 using known cache coherency techniques. In at least one embodiment, a register file 1406 is additionally included in processor(s) 1402, which may include different types of registers for storing different types of data (e.g., integer registers, floating point registers, status registers, and an instruction pointer register). In at least one embodiment, register file 1406 may include general-purpose registers or other registers.

In at least one embodiment, one or more processor(s) 1402 are coupled with one or more interface bus(es) 1410 to transmit communication signals such as address, data, or control signals between processor(s) 1402 and other components in system 1400. In at least one embodiment, interface bus(es) 1410 can be a processor bus, such as a version of a Direct Media Interface (DMI) bus. In at least one embodiment, interface bus(es) 1410 is not limited to a DMI bus, and may include one or more Peripheral Component Interconnect buses (e.g., PCI, PCI Express), memory busses, or other types of interface busses. In at least one embodiment processor(s) 1402 include an integrated memory controller 1416 and a platform controller hub 1430. In at least one embodiment, memory controller 1416 facilitates communication between a memory device and other components of system 1400, while platform controller hub (PCH) 1430 provides connections to I/O devices via a local I/O bus.

In at least one embodiment, a memory device 1420 can be a dynamic random access memory (DRAM) device, a static random access memory (SRAM) device, flash memory device, phase-change memory device, or some other memory device having suitable performance to serve as process memory. In at least one embodiment, memory device 1420 can operate as system memory for system 1400, to store data 1422 and instructions 1421 for use when one or more processor(s) 1402 executes an application or process. In at least one embodiment, memory controller 1416 also couples with an optional external graphics processor 1412, which may communicate with one or more graphics processor(s) 1408 in processor(s) 1402 to perform graphics and media operations. In at least one embodiment, a display device 1411 can connect to processor(s) 1402. In at least one embodiment, display device 1411 can include one or more of an internal display device, as in a mobile electronic device or a laptop device, or an external display device attached via a display interface (e.g., DisplayPort, etc.). In at least one embodiment, display device 1411 can include a head mounted display (HMD) such as a stereoscopic display device for use in virtual reality (VR) applications or augmented reality (AR) applications.

In at least one embodiment, platform controller hub 1430 enables peripherals to connect to memory device 1420 and processor(s) 1402 via a high-speed I/O bus. In at least one embodiment, I/O peripherals include, but are not limited to, an audio controller 1446, a network controller 1434, a firmware interface 1428, a wireless transceiver 1426, touch sensors 1425, a data storage device 1424 (e.g., hard disk drive, flash memory, etc.). In at least one embodiment, data storage device 1424 can connect via a storage interface (e.g., SATA) or via a peripheral bus, such as a Peripheral Component Interconnect bus (e.g., PCI, PCI Express). In at least one embodiment, touch sensors 1425 can include touch screen sensors, pressure sensors, or fingerprint sensors. In at least one embodiment, wireless transceiver 1426 can be a Wi-Fi transceiver, a Bluetooth transceiver, or a mobile network transceiver such as a 3G, 4G, or Long Term Evolution (LTE) transceiver. In at least one embodiment, firmware interface 1428 enables communication with system firmware, and can be, for example, a unified extensible firmware interface (UEFI). In at least one embodiment, network controller 1434 can enable a network connection to a wired network. In at least one embodiment, a high-performance network controller (not shown) couples with interface bus(es) 1410. In at least one embodiment, audio controller 1446 is a multi-channel high definition audio controller. In at least one embodiment, system 1400 includes an optional legacy I/O controller 1440 for coupling legacy (e.g., Personal System 2 (PS/2)) devices to system 1400. In at least one embodiment, platform controller hub 1430 can also connect to one or more Universal Serial Bus (USB) controller(s) 1442 connect input devices, such as keyboard and mouse 1443 combinations, a camera 1444, or other USB input devices.

In at least one embodiment, an instance of memory controller 1416 and platform controller hub 1430 may be integrated into a discreet external graphics processor, such as external graphics processor 1412. In at least one embodiment, platform controller hub 1430 and/or memory controller 1416 may be external to one or more processor(s) 1402. For example, in at least one embodiment, system 1400 can include an external memory controller 1416 and platform controller hub 1430, which may be configured as a memory controller hub and peripheral controller hub within a system chipset that is in communication with processor(s) 1402.

Embodiments presented herein can perform inference orchestration in a distributed resource environment and allowing for network acceleration.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
one or more processors to:
receive a request to perform at least one inferencing operation;
determine, using an inference orchestrator, a sequence of tasks to be performed for the at least one inferencing operation, the tasks including obtaining contextual information from at least one context node and performing the at least one inferencing operation using at least one inference node;
append metadata to the request indicating an ordering in which the request is to be forwarded to the at least one context node and the at least one inference node;
cause the request, with the appended metadata, to be forwarded to the at least one context node and the at least one inference node according to the ordering and independent of the inference operator, the at least one context node to provide the contextual information to be used by the at least one inferencing node to perform the at least one inferencing operation; and
determine, by the inference orchestrator in response to receiving one or more results of the at least one inferencing operation, a response to be sent with respect to the request.

2. The system of claim 1, wherein the inference orchestrator comprises a programmable network device.

3. The system of claim 2, wherein the programmable network device is a data processing unit (DPU) or a smart network interface card (SmartNIC).

4. The system of claim 1, wherein the ordering is determined based in part on a class of the request as determined by the inference orchestrator.

5. The system of claim 1, wherein the request includes a prompt to generate one or more types of content including at least text, image, audio, video, or animation content.

6. The system of claim 1, wherein the at least one context node and the at least one inference node comprise physical computing devices or virtual computing devices.

7. The system of claim 1, wherein the inference orchestrator is able to receive multiple inferencing operation results from at least one inference node and to at least select or combine a result to be returned with the response.

8. The system of claim 1, wherein the at least one inference node is further selected based on at least one preference of a user associated with the request.

9. The system of claim 1, wherein the at least one context node is further selected based in part upon one or more types of contextual information to be obtained, wherein the contextual information may include public or private information based on in part on a type or class of contextual information.

10. The system of claim 1, wherein the inference orchestrator is able to receive a version of the request before a final version of the request if at least one context node. at least one inference node, or at least one processing node lacks a network programmable device for updating and forwarding the request to a next node in sequence.

11. The system of claim 1, wherein the metadata further includes information about a target recipient of the response, the response allowed to be sent by a final inference node or the inference orchestrator.

12. At least one processor comprising:
processing circuitry to:
determine, using an inference orchestrator, a sequence of tasks to be performed for at least one inferencing operation determined for a received inference request, the tasks including obtaining contextual information from at least one context node and performing the at least one inferencing operation using at least one inference node;
append metadata to the request indicating an ordering in which the request is to be forwarded to the at least one context node and the at least one inference node;
cause the request, with the appended metadata, to be forwarded to the at least one context node and the at least one inference node according to the ordering and independent of the inference operator, the at least one context node to provide the contextual information to be used by the at least one inferencing node to perform the at least one inferencing operation; and
determine, by the inference orchestrator in response to receiving one or more results of the at least one inferencing operation, a response to be sent with respect to the request.

13. The at least one processor of claim 12, wherein the ordering is determined based in part on a class of the request as determined by the inference orchestrator.

14. The at least one processor of claim 12, wherein the inference orchestrator is able to receive multiple operation results from at least one inference node or at least one processing node, and to at least select or combine a result to be returned with the response.

15. The at least one processor of claim 12, wherein the inference orchestrator is able to receive a version of the request before a final version of the request if at least one context node, at least one inference node, or at least one processing node lacks a network programmable device for updating and forwarding the request to a next node in sequence.

16. An inference orchestrator, comprising:
at least one processor to determine a sequence of context nodes and inference nodes to process a received inference request and append metadata to the inference request indicating the sequence of context nodes and inference nodes, the context nodes and the inference nodes having one or more programmable network devices allowing for parsing, updating, and forwarding of the inference request to any subsequent nodes in the sequence without a requirement to return the inference request to the inference orchestrator during the sequence.

17. The inference orchestrator of claim 16, wherein the ordering is determined based in part on a class of the request as determined by the inference orchestrator.

18. The inference orchestrator of claim 16, wherein the inference orchestrator is able to receive multiple inferencing operation results from at least one inference node and to at least select or combine a result to be returned with the response.

19. The inference orchestrator of claim 16, wherein the inference orchestrator is able to receive a version of the request before a final version of the request if at least one context node, at least one inference node, or at least one processing node lacks a network programmable device for updating and forwarding the request to a next node in sequence.

20. The inference orchestrator of claim 16, wherein the inference orchestrator is implemented in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.
